(19) United States
(12) Patent Application Publication
(10) Pub. No.: US 2015/0215271 A1
(43) Pub. Date: Jul. 30, 2015

(54) GENERATING SUGGESTED DOMAIN NAMES BY LOCKING SLDS, TOKENS AND TLDS

(71) Applicant: Go Daddy Operating Company, LLC, Scottsdale, AZ (US)

(72) Inventors: Nitin Gupta, Mountain View, CA (US); Edward J. Karcher, III, Chandler, AZ (US); Garrett Matsudaira, Bellevue, WA (US); Tapan Kamdar, San Jose, CA (US)

(21) Appl. No.: 14/683,480

(22) Filed: Apr. 10, 2015

Related U.S. Application Data
(63) Continuation-in-part of application No. 14/289,583, filed on May 28, 2014.
Application No. 14/289,583 is a continuation-in-part of application No. 14/173,346, filed on Feb. 5, 2014.
Application No. 14/173,346 is a continuation-in-part of application No. 14/097,022, filed on Dec. 4, 2013.

(51) Int. Cl. H04L 29/12; G06F 17/30

(52) U.S. Cl. CPC H04L 61/1511; G06F 17/30864

(57) ABSTRACT

A user may enter a user search in a search field. The user search and/or data associated with the user may be used to create a plurality of SLDs and a plurality of TLDs. A plurality of suggested domain names may be created using the SLDs and TLDs and displayed to the user in a single column and the plurality of TLDs may be displayed to the user in a single horizontal row. The location of the displayed suggested domain names and TLDs may be switched in some embodiments. The user search may also be tokenized and the user may select one of the tokens, a displayed SLD or a displayed TLD to lock (or spin in some embodiments) the selected token(s), SLD(s) and/or TLD(s) so that all new displayed suggested domain names include the locked token(s), SLD(s) and/or TLD(s). New suggested domain names may then be created that include the locked token(s), SLD(s) and/or TLD(s) and displayed to the user. The process of locking and unlocking tokens, SLDs and TLDs, creating suggested domain names and displaying them to the user may be repeated as many times as desired.

### CROSS REFERENCE TO RELATED APPLICATIONS

This continuation-in-part application is based upon and claims benefit of priority from the prior U.S. patent application Ser. No. 14/289,583, filed on May 28, 2014, which is a continuation-in-part application based upon and claims the benefit of priority from the prior U.S. patent application Ser. No. 14/173,346, filed on Feb. 5, 2014, which is a continuation-in-part application based upon and claims the benefit of priority from the prior U.S. patent application Ser. No. 14/097,022, filed on Dec. 4, 2013, the entire contents of which are incorporated herein by reference.

### FIELD OF THE INVENTION

The present invention generally relates to spinning and locking SLDs, tokens and/or TLDs to generate and display a plurality of suggested domain names and/or suggested TLDs. The SLDs, tokens and/or TLDs may be generated from a user search and data associated with a user. In preferred embodiments, the suggested domain names are displayed vertically in a single column at the same time as the suggested TLDs are displayed horizontally in a single row. In other embodiments, the suggested domain names are displayed horizontally in a single row while the TLDs are displayed vertically in a single column.

### SUMMARY OF THE INVENTION

The present invention provides methods for spinning name identifiers, such as domain names, using interactive tokens and keywords. An exemplary method may start with a name identifier registering entity, such as, as non-limiting examples, a social media platform, a domain name reseller, Registrar, or Registry, receiving a user search from a user. The user search may be entered in a data entry field on a webpage of a website, generated using information associated with the user found on the Internet or in one or more proprietary databases, or generated from a keyword spinner. The user search may be a domain name or a plurality of words (with our without spaces) and may be parsed into one or more words.

Adjacent or neighboring words may be analyzed to determine if there are any entities, such as, as a non-limiting example, n-grams, in the one or more words. Entities or words that have not been found to be helpful in the past may also be dropped from consideration. In addition, words that are prepositions, pronouns, articles, or that have been found in past to be unhelpful, may be dropped from consideration. The remaining entities and words may be tokenized, i.e. each entity and/or remaining word may be assigned to represent a token. While any number of tokens may be found and used, it is preferable, simply for display and practical reasons (for example, longer domain names or social media handles are generally less desirable than shorter ones), to limit the number of tokens to two, three, four, or five.

Zero or more keywords may be found for each token. The keywords may be synonyms, words related or often associated with one of the tokens, commonly purchased together, and/or experimental words. Each token and its plurality of keywords may be displayed, preferably in a vertical list, on a webpage to the user. Thus, for example, if three tokens are selected, there would be three lists. There are preferably check boxes, data entry fields, menus, tag clouds, or other ways on the webpage to allow the user to select zero or more keywords from each list.

The user may be given the capability to add, delete, edit, reorder, and/or lock tokens. The webpage preferably automatically updates to reflect the user's manipulation of the tokens, e.g. newly added tokens are shown (with corresponding keywords), while deleted tokens (and their keywords) are no longer shown on the webpage.

The user may select zero or more keywords at any time during the process. When the user has finished manipulating the tokens and selected the desired keywords, the user may indicate that the user is ready to spin, i.e. create a new batch of name identifiers, such as domain names or social media handles (names).

Domain names may be created by combining various tokens from a set of keywords and a domain name extension. In a preferred embodiment, only zero or one token or selected keyword from each list is combined with a single domain name extension. Limiting only zero or one token or selected keyword from each list reduces the chance of having synonyms in the same suggested domain name which might unnecessarily and undesirably increase the length of a suggested domain name.

The name identifiers, such as domain names, are preferably prioritized, or a methodology used, so that the name identifiers that are mostly likely to be chosen have a higher priority than name identifiers that are less likely to be chosen. If the number of name identifiers exceeds a predetermined number, the lower priority name identifiers may be dropped from consideration.

The remaining created name identifiers may be checked for availability. Name identifiers that are available may be displayed on a webpage designed for this purpose, preferably with the highest priority name identifiers in the most prominent positions.

The user may select zero or more name identifiers for registration, in which case the selected name identifiers may be registered to the user. As a specific, non-limiting example, selected domain names may be registered with a Registry. Alternatively, or in addition, the user may enter a new user search or add, delete, edit, reorder, and/or lock one or more tokens to cause a new batch of name identifiers to be displayed on a webpage that may be selected for registration.

In another embodiment, a method is disclosed for suggesting a domain name on a website for a user based on the relatedness of one or more tokens (or even keywords) with a domain name's corresponding domain name extension, based on the relatedness of the user with the domain name's corresponding domain name extension, or some combination thereof. In this embodiment, a plurality of tokens may be generated that are associated with a user. A plurality of domain name extensions may be analyzed to determine the domain name extension that is most related to the plurality of tokens, to the user, or to some combination thereof. A domain name may be created by combining one or more tokens in the plurality of tokens with the domain name extension that is most related to the plurality of tokens, to the user, or to some combination thereof. The domain name may then be displayed on the website for the user to select for registration at the user's discretion.

This embodiment may also allow the user to manipulate the tokens on the website. In addition, the availability of the domain name may be checked and only displayed on the website to the user if the domain name is available for registration.

In another embodiment, a method is disclosed for positioning suggested domain names on a website for a user based on the relatedness of one or more tokens with the domain names' corresponding domain name extensions, based on the relatedness of the user with the domain names' corresponding domain name extensions, or some combination thereof. In this embodiment, a plurality of tokens associated with a user may be generated. A plurality of domain name extensions may be ranked based on a relatedness of each domain name extension with the plurality of tokens, with the user, or some combination thereof. A plurality of domain names may be created by repeatedly combining one or more tokens in the plurality of tokens with a domain name extension in the plurality of domain name extensions. Preferably, only top ranked domain name extensions are used to create the plurality of domain names. The domain names that have higher ranked domain name extensions may be presented to the user on the website before domain names that have lower ranked domain name extensions. The user may then select on the website one or more of the presented domain names for registration.

This embodiment may also allow the user to manipulate the tokens on the website. In addition, the availability of the created domain names may be checked prior to being displayed, and only the available domain names are displayed on the website to the user.

In another embodiment, a method is disclosed for positioning suggested domain names on a website for a user based on a payment received from the seller (which could be, as non-limiting examples, an individual or a Registry) and/or a relatedness of one or more tokens with the domain names' corresponding domain name extensions, based on the relatedness of the user with the domain names' corresponding domain name extensions, or some combination thereof. In this embodiment, a plurality of tokens associated with a user may be generated. A plurality of domain name extensions may be ranked based on the payment received from the seller and/or the relatedness of each domain name extension with the plurality of tokens, the relatedness of each domain name extension with the user, or some combination thereof. A plurality of domain names may be created by repeatedly combining one or more tokens in the plurality of tokens with a domain name extension in the plurality of domain name extensions. Preferably, only top ranked domain name extensions are used to create the plurality of domain names. The domain names that have higher ranked domain name extensions may be presented to the user on the website before domain names that have lower ranked domain name extensions. The user may then select on the website one or more of the presented domain names for registration.

This embodiment may also allow the user to manipulate the tokens on the website. In addition, the availability of the created domain names may be checked prior to being displayed, and preferably only the available domain names are displayed on the website to the user.

In another embodiment, a dictionary, containing a first plurality of terms, tokens and/or words (hereafter terms) may be built and stored on a server computer. The dictionary may also store how frequently the terms appear and/or how frequently the terms appear together (co-occurrence) in a body of text. A second plurality of terms may be generated that are associated with a user. A plurality of domain names may be created by combining one or more terms in the second plurality of terms along with a domain name extension. Created domain names comprising frequently used terms and/or co-occurring terms, according to the dictionary, may be displayed more prominently, before or instead of domain names that comprise less frequently used and/or less co-occurring terms on a website for the user to select for registration, at the user's discretion.

In another embodiment, a user search entered by a user in a search field on a webpage may be analyzed by a backend of the webpage (comprising one or more servers) as each character of the user search is entered by the user. The backend of the webpage may tokenize the user search into one or more tokens in real time as additional characters are entered by the user. While any token in the user search may be analyzed, manipulated, spun and/or deleted, in preferred embodiments, the last token (which could be the first token if only one token has been entered by the user) is analyzed to determine whether the last token is a word.

The last token may be compared against known words in an electronic dictionary to make this determination. If the last token is a word, a plurality of related tokens may be determined that have a similar meaning and/or are related to the last token. Synonym dictionaries may be used to find words having a similar meaning and/or bodies of text may be used to find words that are related to the last token.

If the last token is not a word, a plurality of related tokens may be determined that are the most likely anticipated completions (query completions) to the last token. Databases may be created and used that comprise prefixes (prefixes may be considered the last token that is not a word) with corresponding anticipated completions and with frequency or occurrence numbers. As an example, a prefix of “bik” might have an anticipated completion of “bike” and a number of occurrences of 20. Thus if the backend determines the last token is “bik,” one of the related tokens may be “bike,” if “bike” occurs more often (based on the 20) than other anticipated completions of “bik” that would have their own frequency or number of occurrences.

The backend of the webpage may display a plurality of suggested searches, preferably displaying the plurality of suggested searches immediately below the search field. Each suggested search may comprise all of the tokens (which could be one or more) found in the user search except that the last token is preferably replaced by one of the related tokens (typically either a synonym or an anticipated completion of the last token) in the plurality of related tokens.

In some embodiments, TLDs (extensions) and/or related domain names may also be updated (ether as the user enters each character in the user search or when the user selects a “search now” button) on the webpage. The user may continue entering characters in the user search, select one of the suggested searches, lock one of the extensions (causing all displayed related domain names to have that extension) or select one of the displayed related domain names for domain name registration. If the user selects one of the suggested searches, a new batch of extensions and related domain names may be determined based on the selected suggested search.

In another embodiment a TLD may be locked into place so that the TLD appears in all suggested domain names. In this embodiment a user may enter a user search in a search field on a display. The display may be part of a website or an application program operating on any device, but is preferably the display on a mobile device with a limited display area. The user search and/or data associated with the user (possibly stored in a database) may be used to spin a plurality of SLDs and a plurality of TLDs. A plurality of suggested domain names may be created by combining one of the plurality of SLDs with one of the plurality of TLDs. The plurality of suggested domain names is preferably displayed in one, and only one, vertical column at the same time the plurality of TLDs (without any associated SLDs) is displayed in one, and only one, horizontal row on the display to the user. The user preferably does not see any other SLDs or any other TLDs (although pricing information may be displayed) on the display that are not part of the user search, the suggested domain name in the vertical column or the plurality of TLDS in the horizontal row. In some embodiments, the TLDs may be placed in the single vertical column while the suggested domain names are in the single horizontal row. The user may select, possibly by touching the display, one or more of the displayed TLDs. A second plurality of suggested domain names may be created that all include one of the selected TLD(s). The first plurality of suggested domain names may be removed and the second plurality of suggested domain names may be displayed to the user on the display in a single vertical column. In some embodiments, the first plurality of suggested domain names may be removed merely by displaying the second plurality of suggested domain names in the same location, i.e., displaying the second plurality of suggested domain names automatically removes the first plurality of suggested domain names without further action. Data associated with the user, such as the selected TLD(s), may be stored in a database for use in future processes.

In another embodiment, a user search, entered in a search field on a webpage or on an application running on a mobile device, may be received by a backend processing system and tokenized into one or more tokens. The plurality of tokens and/or data associated with the user (possibly read from a database by the backend) may be used to create a plurality of SLDs and a plurality of TLDs. A plurality of suggested domain names may be created by combining one of the SLDs in the plurality of SLDs with one of the TLDs in the plurality of TLDs. The plurality of suggested domain names are preferably displayed in a single vertical column (no other suggested domain names are displayed) at the same time the plurality of TLDs are preferably displayed in a single horizontal row (no other TLDs are displayed). The user search and/or tokens may also be displayed. In some embodiments, the location of the plurality of suggested domain names may be switched with the location of the plurality of TLDs. The user may select one or more SLDs, one or more tokens and/or one or more TLDs from the displayed SLDs, tokens and TLDs. The user may select and unselect any number, order or combinations of SLD(s), token(s) and TLD(s). The backend, possibly after receiving a request from the user to do another search, may create a second plurality of suggested domain names based on the selected SLDs, tokens and TLDs. The process of selecting and unselecting SLDs, tokens and/or TLDs, spinning the selected SLDs, tokens and/or TLDs, creating different pluralities of suggested domain names and displaying each created plurality of suggested domain names in one, and only one, vertical column (or in some embodiments, one and only one, horizontal row) may be repeated any number of times as desired by the user.

In another embodiment, the user may swipe the display (move the user's hand across the display) in a horizontal or a vertical manner. A horizontal swipe may cause new TLDs (or suggested domain names if the suggested domain names are displayed horizontally) to be displayed in a horizontal row on the display to the user. A vertical swipe may cause new suggested domain names (or suggested TLDs if the TLDs are displayed vertically) to be displayed in a vertical column on the display to the user. The vertical and horizontal swipes preferably leave only one column and one row of suggested domain names and TLDs and the user search displayed on the device to the user.

In some embodiments one or more tokens and/or one or more TLDs are selected to be locked (appear in all suggested domain names) or selected to spin (synonyms or other words appear in all suggested domain names in place of the selected tokens and/or TLDs). Additional suggested domain names may be created and then displayed in a singe vertical column based on the locked and/or spun SLDs, tokens and/or TLDs.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the present invention.

FIG. 2 illustrates a portion of a webpage of a website for allowing a user to enter a user search into a data entry field.

FIG. 3 illustrates possible tokens that may be created from an example user search.

FIG. 4 illustrates a portion of a webpage displaying a plurality of lists, wherein each list comprises a token and keywords related to the token.

FIG. 5 illustrates a portion of a webpage displaying a plurality of lists, wherein each list comprises a token and keywords related to the token.

FIG. 6 illustrates a portion of a webpage displaying a plurality of lists, wherein each list comprises a token and keywords related to the token.

FIG. 7 illustrates a portion of a webpage displaying a plurality of lists, wherein each list comprises a token and keywords related to the token.

FIG. 8 illustrates a portion of a webpage displaying a plurality of lists, wherein each list comprises a token and keywords related to the token.

FIG. 9 illustrates a portion of a webpage displaying a plurality of available domain names created based on the tokens and selected keywords.

FIG. 10 is a first part of a flow diagram illustrating an example embodiment of a method for domain name spinning using interactive keywords.

FIG. 11 is a second part of a flow diagram illustrating an example embodiment of a method for domain name spinning using interactive keywords.

FIG. 12 is a table illustrating a relatedness of a plurality of tokens to a plurality of domain name extensions.

FIG. 13 is a flow diagram illustrating an example embodiment of a method for practicing the invention.

FIG. 14 is a flow diagram illustrating an example embodiment of a method for practicing the invention.

FIG. 15 is a flow diagram illustrating an example embodiment of a method for practicing the invention.

FIG. 16 is a flow diagram illustrating an example embodiment of a method for practicing the invention using term frequency and/or term co-occurrence.

FIG. 17 is a flow diagram illustrating an example embodiment of a method for generating suggested searches for domain names using a user entered user search comprising a first and a second token.

FIG. 18 is a flow diagram illustrating an example embodiment of a method for generating suggested searches for domain names by determining how frequently related tokens (related to the second token) appear after the first token in past user domain name searches.

FIG. 19 is a flow diagram illustrating an example embodiment of a method for generating suggested searches for domain names by determining related tokens to a second token based at least partially upon the meaning and/or context provided by a first token.

FIG. 20 is a flow diagram illustrating an example embodiment of a method for generating suggested searches for domain names by determining related tokens to a lost token in a plurality of tokens entered by a user in a search field.

FIG. 21 is a flow diagram illustrating an example embodiment of a method for generating suggested searches for domain names and then suggested domain names by determining related tokens to a lost token in a plurality of tokens entered by a user in a search field.

FIG. 22 is an illustration of a possible webpage at the beginning of a method for creating suggested searches and related domain names with an empty Search Field, no locked extensions, no suggested searches and no displayed related domain names.

FIG. 23 is an illustration of a possible webpage with a “b” in the Search Field, suggested searches, no locked extensions and displayed related domain names.

FIG. 24 is an illustration of a possible webpage with a “bike” in the Search Field, suggested searches, no locked extensions and displayed related domain names.

FIG. 25 is an illustration of a possible webpage with a “bikechain” in the Search Field, suggested searches, no locked extensions and displayed related domain names.

FIG. 26 is a flow diagram illustrating one possible embodiment of spinning and locking SLD and/or TLDs and displaying the generated suggested domain names in a single vertical column and the generated suggested TLDs in a single horizontal row or displaying the generated suggested domain names in a single horizontal row and the generated suggested TLDs in a single vertical column.

FIG. 27 is a flow diagram illustrating the method described in FIG. 26 followed by the steps of locking a TLD and spinning and displaying a new plurality of suggested domain names in a single vertical column to be displayed over/instead of the original suggested domain names.

FIG. 28 is a flow diagram illustrating the additional step of storing a user search, selected SLDs, selected tokens and/or selected TLDs. The stored user search, selected SLDs, selected tokens and/or selected TLDs may be used to generate future suggested domain names, SLDs, tokens and TLDs for the user and/or other users.

FIG. 29 is a flow diagram illustrating a process for the user to make a horizontal swipe on the display to display a new plurality of TLDs.

FIG. 30 is a flow diagram illustrating a process for the user to make a vertical swipe on the display to display a new plurality of suggested domain names.

FIG. 31 is a flow diagram illustrating one possible embodiment of spinning and locking SLDs, tokens and/or TLDs and displaying the generated suggested domain names in a single vertical column and the generated suggested TLDs in a single horizontal row or displaying the generated suggested domain names in a single horizontal row and the generated suggested TLDs in a single vertical column.

FIG. 32 is a flow diagram illustrating the method described in FIG. 31 followed by additional steps of locking and/or spinning additional tokens to create new suggested domain names that replace or are displayed instead of the previous suggested domain names.

FIGS. 33-35 illustrate possible displays for displaying suggested domain names and suggested TLDs while practicing various embodiments of the invention.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

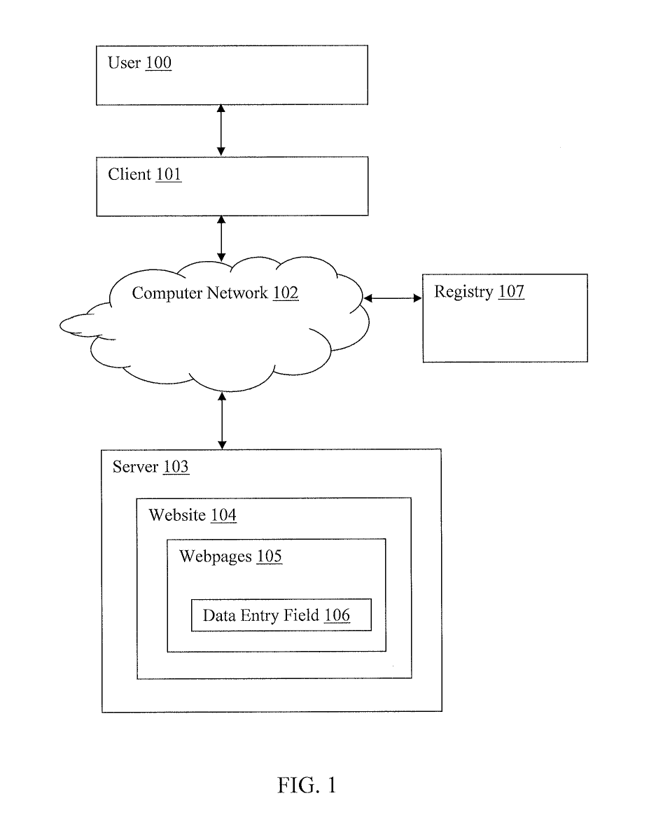

FIG. 1 is a block diagram of a system that may be used to practice the present invention. A computer network 102 is a collection of links and nodes (e.g., multiple computers and/or other devices connected together) arranged so that information may be passed from one part of the computer network 102 to another over multiple links and through various nodes. Examples of computer networks 102 include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users 100 on clients 101. Hundreds of millions of people around the world have access to computers (clients 101) connected to the Internet via Internet Service Providers (ISPs). Content providers place multimedia information (e.g., text, graphics, audio, video, animation, and other forms of data) at specific locations on the Internet referred to as websites 104. The combination of all the websites and their corresponding web pages on the Internet is generally known as the World Wide Web (VVVVVV) or simply the Web.

For Internet users 100 and businesses alike, the Internet continues to be increasingly valuable. More people use the Web for everyday tasks, from social networking, shopping, banking, and paying bills to consuming media and entertainment. E-commerce is growing, with businesses delivering more services and content across the Internet, communicating and collaborating online, and inventing new ways to connect with each other.

Prevalent on the Web are multimedia websites 104, some of which may offer and sell goods and services to individuals and organizations. Websites 104 may consist of a single webpage 105, but typically consist of multiple interconnected and related webpages 105. Websites 104, unless very large and complex or have unusual traffic demands, typically reside on a single server 103 and are prepared and maintained by a single individual or entity (although websites 104 residing on multiple servers 103 are certainly possible). Menus, links, tabs, etc. may be used to move between different web pages 105 within the website 104 or to move to a different website.

Websites 104 may be created using HyperText Markup Language (HTML) to generate a standard set of tags that define how the webpages 105 for the website 104 are to be displayed. Users 100 of the Internet may access content providers' websites 104 using software known as an Internet browser, such as MICROSOFT INTERNET EXPLORER or MOZILLA FIREFOX. After the browser has located the desired webpage 105, it requests and receives information from the webpage, typically in the form of an HTML document, and then displays the webpage content for the user 100 on the client 101. The user 100 then may view other webpages 105 at the same website 104 or move to an entirely different website using the browser.

Some Internet users 100, typically those that are larger and more sophisticated, may provide their own hardware, software, and connections to the Internet. But many Internet users 100 either do not have the resources available or do not want to create and maintain the infrastructure necessary to host their own websites. To assist such individuals (or entities), hosting companies exist that offer website hosting services. These hosting providers typically provide the hardware, software, and electronic communication means necessary to connect multiple websites to the Internet. A single hosting provider may literally host thousands of websites on one or more hosting servers 103.

Browsers are able to locate specific websites 104 because each website 104, resource, and computer on the Internet has a unique Internet Protocol (IP) address. Presently, there are two standards for IP addresses. The older IP address standard, often called IP Version 4 (IPv4), is a 32-bit binary number, which is typically shown in dotted decimal notation, where four 8-bit bytes are separated by a dot from each other (e.g., 64.202.167.32). The notation is used to improve human readability. The newer IP address standard, often called IP Version 6 (IPv6) or Next Generation Internet Protocol (IPng), is a 128-bit binary number. The standard human readable notation for IPv6 addresses presents the address as eight 16-bit hexadecimal words, each separated by a colon (e.g., 2EDC:BA98:0332:0000:CF8A:000C:2154:7313).

IP addresses, however, even in human readable notation, are difficult for people to remember and use. A Uniform Resource Locator (URL) is much easier to remember and may be used to point to any computer, directory, or file on the Internet. A browser is able to access a website 104 on the Internet through the use of a URL. The URL may include a Hypertext Transfer Protocol (HTTP) request combined with the website's 104 Internet address, also known as the website's 104 domain name. An example of a URL with a HTTP request and domain name is: http://www.companyname.com. In this example, the “http” identifies the URL as a HTTP request and the “companyname.com” is the domain name.

Domain names are much easier to remember and use than their corresponding IP addresses. The Internet Corporation for Assigned Names and Numbers (ICANN) approves some Generic Top-Level Domains (gTLD) and delegates the responsibility to a particular organization (a “registry”) for maintaining an authoritative source for the registered domain names within a TLD and their corresponding IP addresses. For certain TLDs (e.g., .biz, .info, .name, and .org) the Registry 107 is also the authoritative source for contact information related to the domain name and is referred to as a “thick” Registry 107. For other TLDs (e.g., .com and .net) only the domain name, registrar identification, and name server information is stored within the Registry 107, and a Registrar is the authoritative source for the contact information related to the domain name. Such Registries 107 are referred to as “thin” registries 107. Most gTLDs are organized through a central domain name Shared Registration System (SRS) based on their TLD. TLDs may also be referred to as domain name extensions.

The process for registering a domain name with .com, .net, .org, and some other TLDs allows an Internet user 100 to use an ICANN-accredited Registrar to register their domain name. For example, if an Internet user 100, John Doe, wishes to register the domain name “mycompany.com,” John Doe may initially determine whether the desired domain name is available by contacting a domain name registrar. The Internet user 100 may make this contact using the Registrar's webpage and typing the desired domain name into a field on the registrar's webpage created for this purpose. Upon receiving the request from the Internet user 100, the Registrar may ascertain whether “mycompany.com” has already been registered by checking the SRS database associated with the TLD of the domain name or by checking with the Registry. The results of the search then may be displayed on the webpage to thereby notify the Internet user 100 of the availability of the domain name. If the domain name is available, the Internet user 100 may proceed with the registration process. If the domain name is not available for registration, the Internet user 100 may keep selecting alternative domain names until an available domain name is found.

A current problem many Internet users 100 face is trying to find a domain name that is available. A similar problem exists in trying to find a handle or name with a social media platform. It is generally desirable to have a domain name (or social media handle) that is as generic and short as possible. A generic domain name makes a website 104 easier to find, thereby increasing its traffic, while shorter domain names are easier to remember and enter into a browser. Unfortunately, many people want the same short generic domain names making it difficult for new Internet users 100 to find a good domain name that is not already registered. The present invention addresses the problem of finding a good available domain name or social media handle.

A user 100 will typically be a person trying to register one or more domain names or a social media handle. The user 100 may use a client 101, such as, as non-limiting examples, a cell phone, PDA, tablet, laptop computer, or desktop computer to access a website 104 via a computer network 102, such as the Internet.

The website 104 may have a plurality of webpages 105. The website 104 may be hosted or operated from a server 103. The server 103 may be, as a non-limiting example, one or more Dell PowerEdge(s) rack server(s), HP Blade Servers, IBM Rack or Tower servers, although other types of servers, combinations of one or more servers, server software and applications may be used. The webpages 105 may have one or more display fields as well as one or more data entry fields 106. The data entry fields 106 allow the user 100 to enter data into the website 104 from a client 101.

One or more Registries 107 may be connected to the computer network 102, which is preferably the Internet, so that the Registries' 107 functions may be easily accessed by electronic commands. While any number of different functions from the Registry 107 may be used, the present invention is primarily concerned with using the Registry 107 to determine if one or more domain names are available for registration and registering one or more domain names to the user 100. A similar process may be used for social media platforms instead of domain name Registries 107.

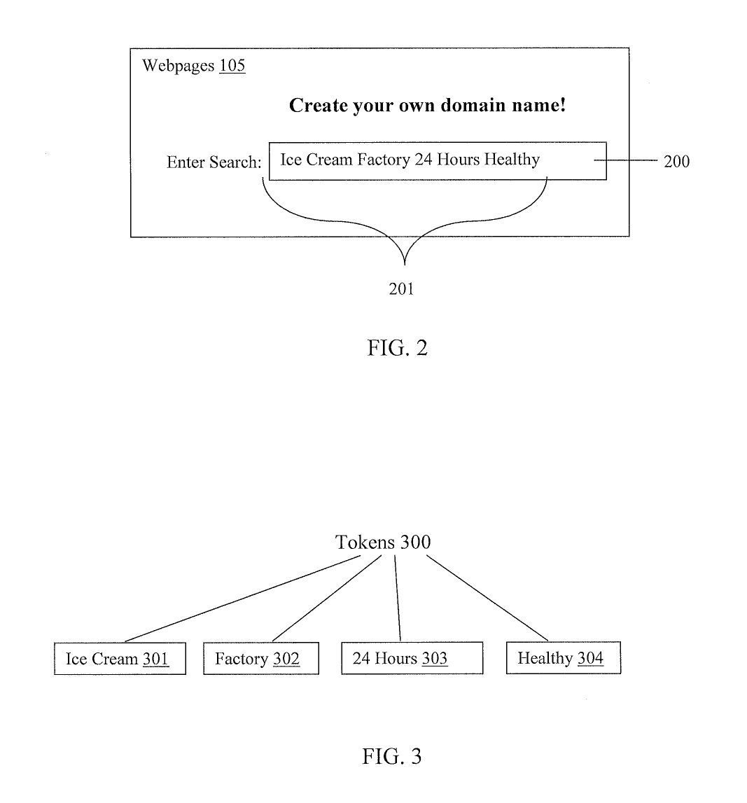

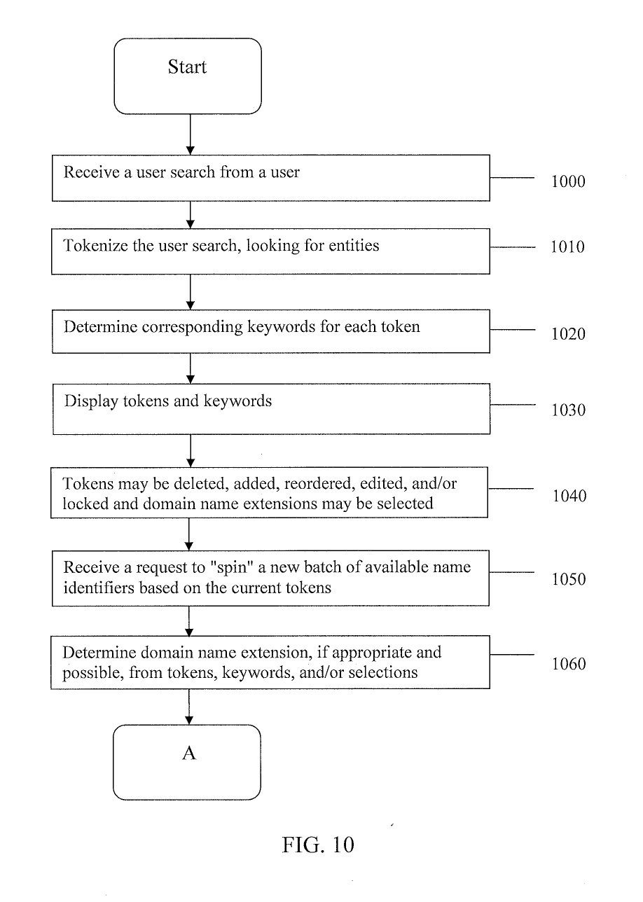

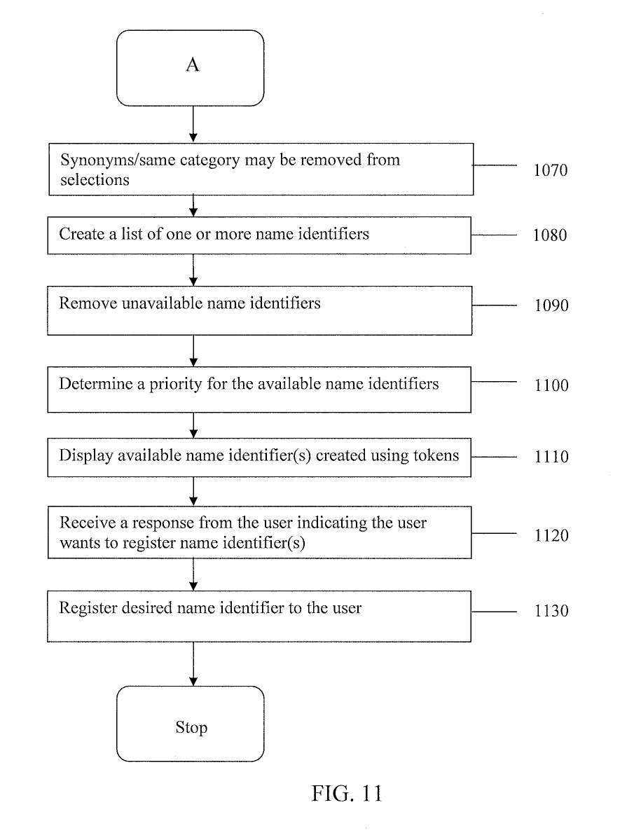

An exemplary process for practicing the invention is illustrated in FIGS. 10 and 11. A user 100 may enter a user search 201 into a data entry field 200 on a webpage 105 of a website 104 as illustrated in FIG. 2. (Step 1000) In FIG. 2, the user 100 has entered a user search 201 of “Ice Cream Factory 24 Hours Healthy” from the user's client 101. The user 100 may enter any number of different character strings that may be received and analyzed as a user search 201, by a server 103, with the current invention.

The server 103 tokenizes the user search 201 into one or more tokens 300. The user search 201 may be a domain name, string of characters, a string of words, and/or some combination thereof. The tokenization process preferably begins by parsing the user search 201 into a plurality of words or character strings. In the example from FIG. 2, the words and character strings found may be “Ice,” “Cream,” “Factory,” “24,” “Hours,” and “Healthy.” Domain names are not case sensitive, thus either capital or non-capital letters may be used for the words, entities, and/or tokens 300 depending on visual preference.

In another embodiment, the user 100 does not have to enter a user search 201 for a plurality of tokens 300 to be generated and displayed. As an example, information may be found, preferably online or in one or more proprietary databases, that is associated with the user 100 and this information may be used to generate a plurality of tokens 300 associated with the user 100. As another option, a keyword spinner may be used to generate a plurality of tokens 300 using any known, or later developed, method of spinning words. As non-limiting examples, the user search 201 and/or tokens 300 may be generated and displayed by combining various subcombinations and combinations of words associated with the user 100, random words, words that have been selected in the past by the same or different users 100, the user's name, address or location, associated businesses' names, past purchases, social media handles or data, data from proprietary databases, hobbies, or any other online personal, recreational, business, and/or professional information.

Adjacent or neighboring words and character strings in the user search 201 may be examined to determine how often the words appear next to each other in general use. This may be accomplished by searching for the word combinations in one or more online or proprietary databases. Groups of words and character strings that appear next to each other frequently may be consider an entity and be assigned to a single token 300. In the current example, the entity “Ice Cream” and “24 Hours” may be discovered. The tokens 300 may remain “Ice,” “Cream,” “24,” and “Hours,” but are preferably reformatted to “Ice Cream” 301 and “24 Hours” 303.

Prepositions, pronouns, articles, stop words, etc. (that are not part of an entity) may be removed from consideration. The remaining words (“Factory” and “Healthy”) and entities (“Ice Cream” and “24 Hours”) may be considered tokens 300 and prioritized. The prioritization may be based, as non-limiting examples, on how often the words or entities have been selected for domain name registration in the past or by the order the words and entities were entered into the data entry field, i.e. from left to right.

While any number of tokens 300 may be used, in a preferred embodiment only four tokens 300 or less, having the highest priority, are used. Thus, as shown in FIG. 3, the tokens 300 in the current example, prioritized in the order the words were entered into the data entry field 200, are “Ice Cream” 301, “Factory” 302, “24 Hours” 303, and “Healthy” 304. (Step 1010)

For each token 300, zero or more corresponding keywords 400 may be found. The keywords 400 may be, as non-limiting examples, synonyms, related words, commonly purchased together words, experimental words, associated in a database, determined by analysis of domain name search logs, determined to have grammatical similarities, i.e. parts of speech, associations through search engines, thesauruses, and/or found using synonym generators with one of the tokens 300. (Step 1020)

In one embodiment for selecting keywords 400, previous domain name search logs may be analyzed. For example, if domain names containing “Ice Cream” were unavailable and past users 100 consistently selected alternative domain names containing “Gelato,” then “Gelato” would preferably be made one of the keywords 400 associated with the token “Ice Cream.”

The keywords 400 are preferably prioritized and listed in their order of priority under each token with the highest priority keywords 400 being placed at the top of the list. Higher priority keywords 400 may be made a different color, font, size, bold, highlighted, background, etc. or placed in a tag cloud to encourage the selection of the higher priority keywords 400. The keywords 400 may be ranked, as non-limiting examples, based on the number of users 100 that have selected the keyword 400 in the past, past domain name selections and/or domain names registered that contain the keyword 400. This criteria can be further broken down, for example, by prioritizing keywords 400 in registered domain names above keywords in domain names only selected for registration, but where the user 100 never finished the registration process for the domain name. In another embodiment, the keywords may be presented in a tag cloud, near their associated token, for selection, with higher priority keywords larger or made more prominent than lower priority keywords.

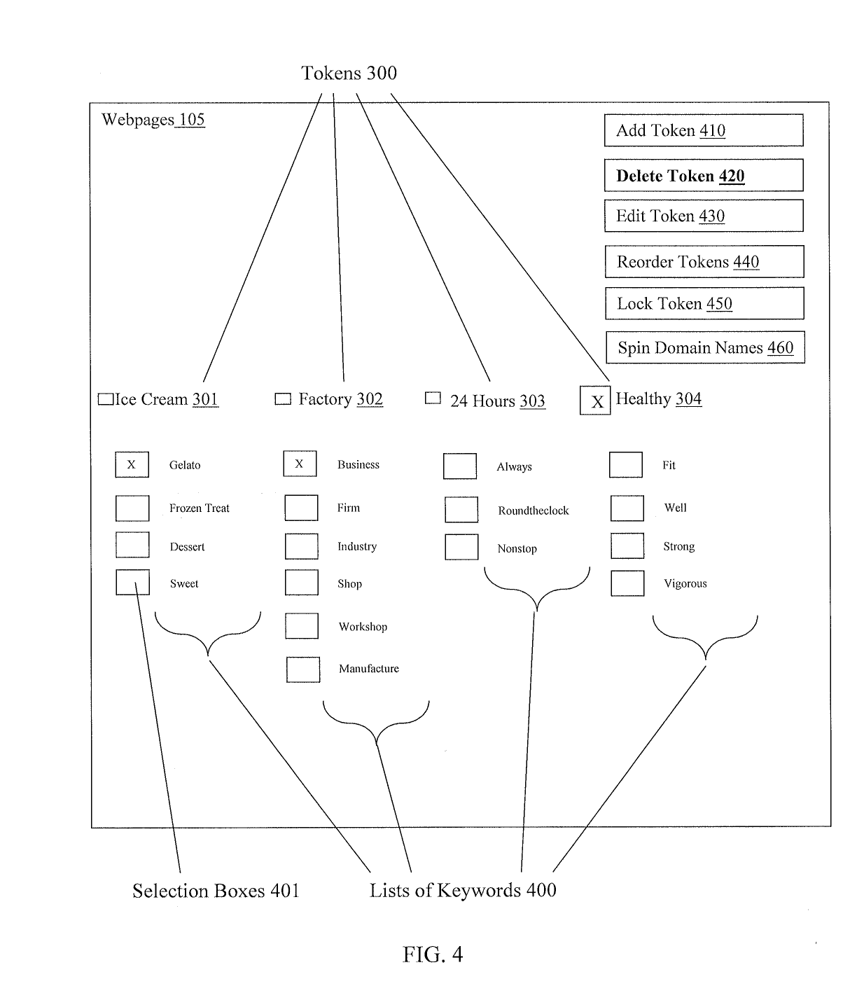

The tokens 300 and keywords 400 may be arranged in lists, with each token and the token's associated keywords 400 forming a list, and displayed on a webpage 105 as shown in FIG. 4. The lists are preferably arranged in order of priority, as previously determined, with the highest priority token 300 farthest to the left and the lowest priority token 300 farthest to the right on the webpage 105. In the illustrated example, the tokens 300 “Ice Cream” 301, “Factory” 302, “24 Hours” 303, and “Healthy” 304 are arranged in that order, from left to right, as that was the order of priority the tokens 300 received based on the order the tokens 300 were entered into the data entry field 200 by the user 100.

While not shown in the embodiment illustrated in FIG. 4, a list, preferably on the right side of all the tokens 300, may be displayed showing domain name extensions or TLDs. In this embodiment, the user 100 may select one or more domain name extensions to use in spinning domain names. Alternatively, the domain name extensions may also be selected based on the user search 201, selected keywords 400 and/or tokens 300.

The user 100 may decide to add another token 300, delete a token 300, edit a token 300, reorder tokens 300, lock a token 300, select zero or more keywords from each displayed list, select zero or more domain name extensions, and/or decide to spin a new batch of available domain names (or social media handles) based on the currently displayed tokens 300. (Step 1040) Any of these actions may be taken without the user 100 having to reenter the user search 201, thereby greatly simplifying the process of spinning domain names for the user 100 since the user 100 only has to enter the user search 201 one time (although the user 100 could enter a new user search 201 if the user 100 so desired.)

While specific buttons (“Add Token” 410, “Delete Token” 420, “Edit Token” 430, “Reorder Tokens” 440, “Lock Token” 450, and “Spin Domain Names” 460) are displayed on the webpage 105 in FIG. 4, it should be understood that any known, or developed in the future, method may be used to allow the user 100 to indicate the user's 100 desires, such as to manipulate the tokens 300 or perform various functions on the webpage 105. As non-limiting examples, fixed menus, pull-down menus, radio buttons, tabs, bars, left or right mouse clicks, pulling or dragging icons, text entry boxes, check boxes, soft buttons, touch screens, voice activation or commands, and/or any other method for manipulating the tokens 300 or initiating an action may be used by the user 100.

Delete a Token

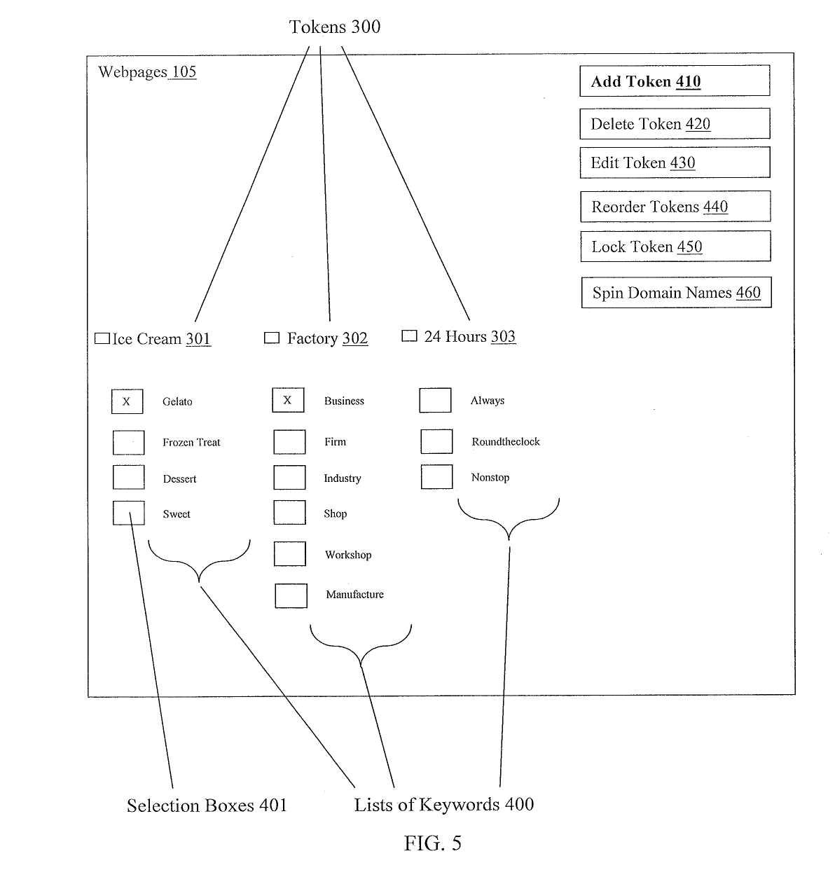

The user 100 may decide to delete one of the active and displayed tokens 300. For example, the user 100 may decide to delete, i.e., not use, the token 300 “Healthy” 304 in spinning new domain names (or social media handles). In such a situation, the user 100 may provide an indication that the user 100 desires to delete one of the tokens 300. As one possible non-limiting mechanism for deleting a token 300, the user 100 may place a check in a box in front of the token 300 desired to be deleted (in this case “Healthy” 304) and select the “Delete Token” 420 button. As another non-limiting example, the text “Health” 304 may be dragged to a trash can icon (not shown) using a mouse, stylus, or touch screen. As another non-limiting example, the text “Health” 304 may be right clicked on causing a menu to appear that includes the option to delete the token 300. After deleting the token “Health” 304, the webpage 105 may be automatically updated by the server 103 to reflect that the token 300 “Healthy” 304 is no longer active, i.e. the token “Healthy” 304 and its associated keywords 400 may be removed from the webpage 105. FIG. 5 illustrates the webpage 105 after the token 300 “Healthy” 304 has been deleted.

Add a Token

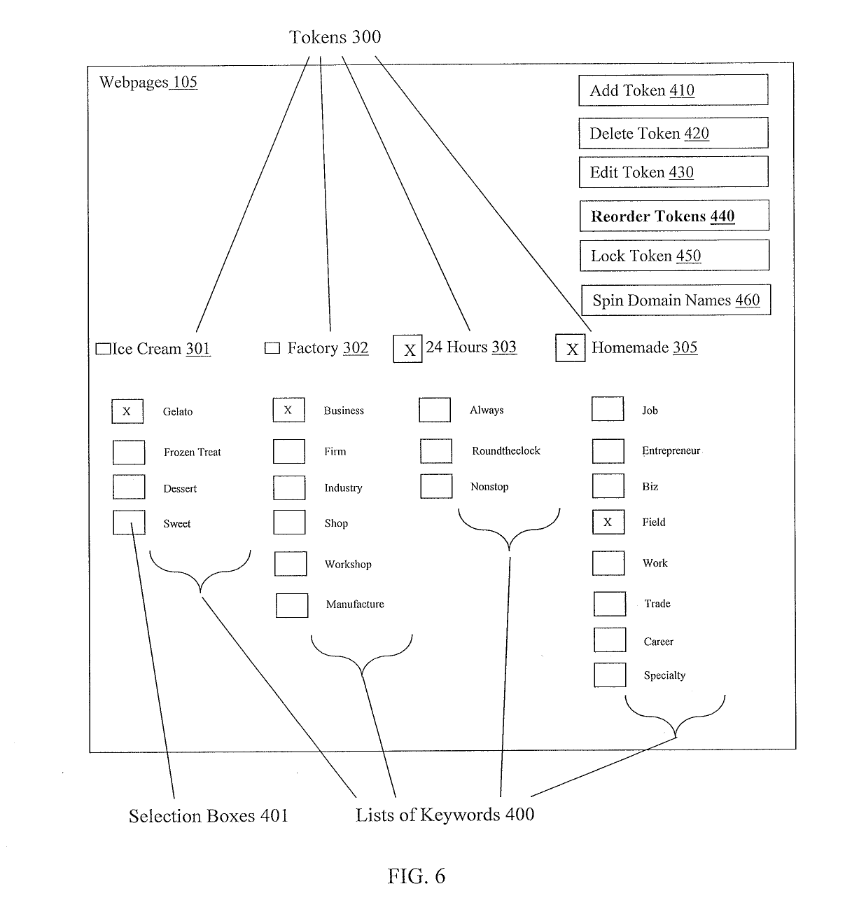

The user 100 may decide to add a new token and, optionally, the order of the new token 300 in relation to the existing tokens 300. For example, the user 100 may decide to add the token 300 “Homemade” 305 to the end of the list of tokens 300 illustrated in FIG. 5. The user 100 may provide an indication that the user 100 desires to add the new token 300 using any known, or later discovered, method in the art. As non-limiting examples, the new token may be verbally entered, the user 100 may click on a position at the start, end, or in between tokens 300 and enter the new token, or the user 100 may select the “Add Token” 410 button and enter a token 300 in a data entry field created for this purpose. As a specific example, the user 100 may enter “Homemade” 305 in a data entry field. The webpage 105 may be automatically updated to reflect that a new token “Homemade” 305 has been added. FIG. 6 illustrates the webpage 105 after the token 300 “Homemade” 305 has been added to the right of the other active tokens 300, although, in a preferred embodiment, the new token may be added to any position of the tokens 300.

Reorder Tokens

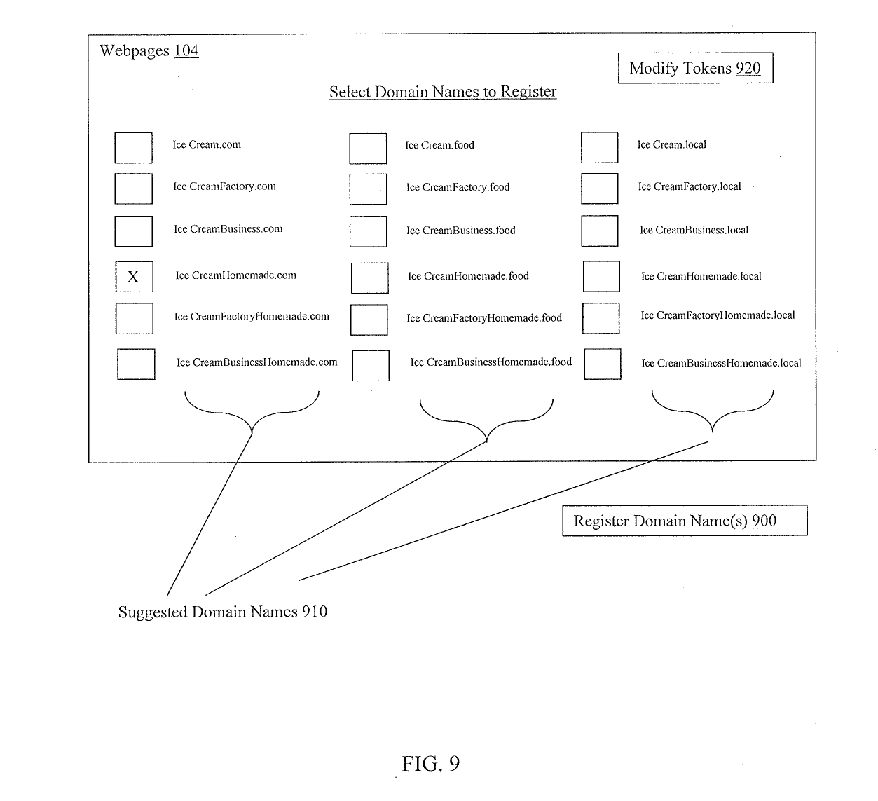

The user 100 may decide to reorder the tokens 300, which also has the effect of reordering the lists of keywords. For some embodiments, the ability to reorder tokens 300 is important since the created suggested domain names 901, shown in FIG. 9, are preferably created by concatenating selections from the lists from left to right. This means, in certain embodiments, tokens 300 or keywords that appear to the left on webpage 105 will be to the left of tokens 300 or keywords that appear to the right on webpage 105 in all suggested domain names 901 (or social media handles). This embodiment allows the user 100 to control the order of the tokens 300 and selected keywords 400 as they appear in the created and suggested domain names 901 (or social media handles).

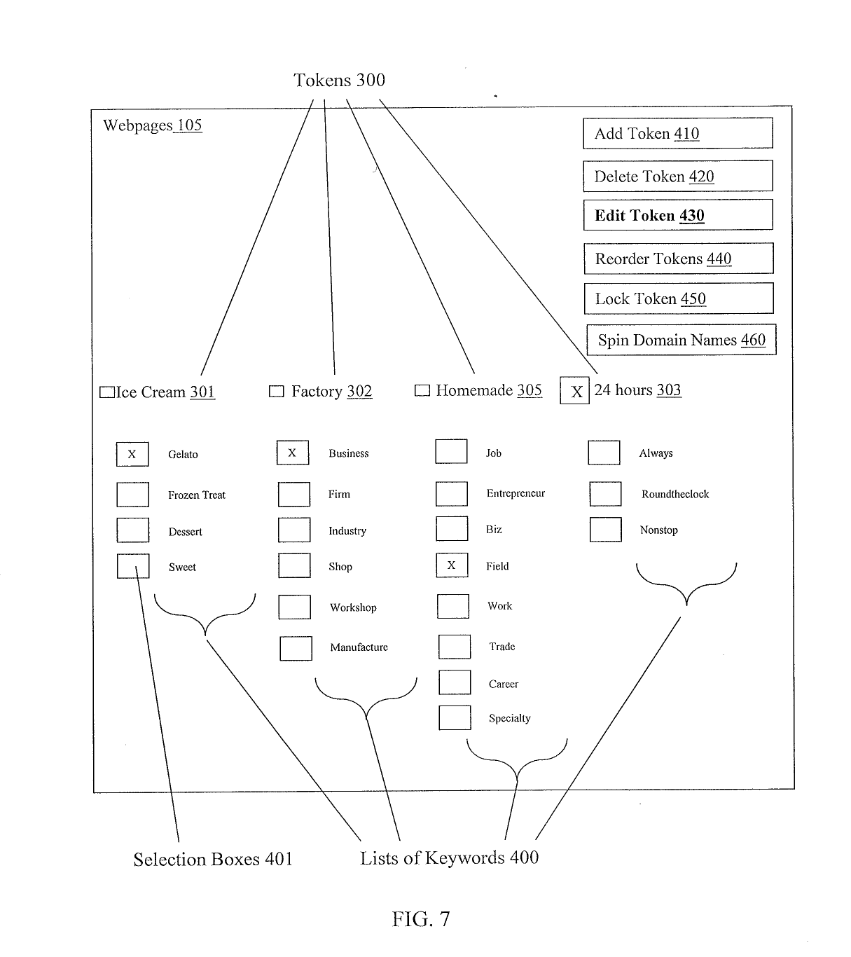

The user 100 may provide an indication that the user 100 desires to reorder one or more tokens 300 (and thus the tokens' 300 associated keywords 400) using any known, or later developed, method. As one non-limiting example, the user 100 may drag and drop a token 300 into a new position (such as between two other existing tokens 300). In another non-limiting example, the user 100 may place a check mark in front of boxes in front of tokens 300 that are desired to be reordered. This is illustrated in FIG. 6. A check has been placed in front of “24 Hours” 303 and in front of “Homemade” 305. The user 100 may then select the “Reorder Tokens” 440 button to cause the two tokens 300 to be reordered (switched in this example) as illustrated in FIG. 7.

Edit Token

The user 100 may decide to edit one of the tokens 300. The user 100 may provide an indication that the user 100 desires to edit a token using any known, or later developed, method. As one non-limiting example, the user 100 may click on the token desired to be edited and edit the text of the token. The edited token may differ from the original token by a single character, the edited token may be an entirely different word or entity, or anything in between. Preferably, the editing process is similar to that performed in word processing applications.

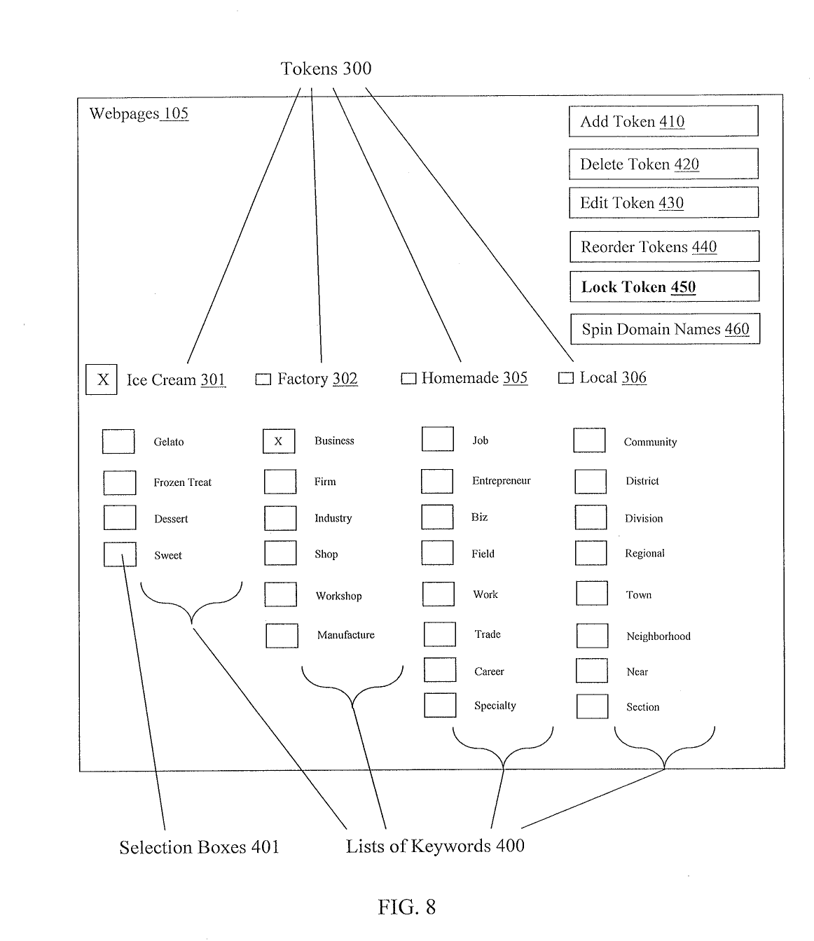

After receiving the edited token, zero or more corresponding keywords 400 may be found. The keywords may be, as non-limiting examples, synonyms, categorically related, associated in a database, determined by analysis of domain name search logs, determined to have grammatical similarities, i.e. parts of speech, associations through search engines, thesauruses, and/or found using synonym generators with the edited token. A new list may be created for the edited token and its corresponding keywords. This new list with the edited token and new corresponding keywords may be automatically displayed on the webpage 105, while the list of the token before it was edited is preferably deleted and no longer displayed on the webpage 105. FIG. 8 shows a possible result after the token “24 Hours” 303 was edited to be “Local” 306 from FIG. 7.

Lock Token

The user 100 may decide to lock one or more of the tokens 300. This option allows the user 100 to be sure that every suggested domain name or social media handle will include the locked token(s) 300. The user 100 may provide an indication that the user 100 desires to lock a token 300 using any known or later developed method of entering data into a webpage 105. As one non-limiting example, FIG. 8 illustrates how the user 100 may place a check mark in front of a token 300 (in this example “Ice Cream” 301) and then selects a “Lock Token” 450 button. As another non-limiting example, there may be a box or selection feature for each token that may be selected to indicate that one or more of the tokens 300 is locked. Optionally, locked tokens 300 may be marked, such as by changing the color of their text, size of their font, using bold text, or by other visual methods.

Select Keywords

The user 100 may select zero or more keywords from each token's list of keywords using any known, or latter developed, method. The keywords 400 may be concatenated together with tokens 300 and/or keywords from other lists in subcombinations and combinations to form suggested domain names 901 or social media handles during the spinning process. A limit may be placed on the number of keywords 400 that the user 100 may select from each list to prevent the number of possible name identifiers (permutations) to become too burdensome to create and verify availability.

Select Domain Name Extension(s)

The user 100 may also have the option of selecting one or more domain name extensions in a manner similar to that used to select tokens 300 and keywords 400. This allows the user 100 to be sure that every suggested domain name will have one of the user's 100 selected domain name extensions. In another embodiment, the system may determine, based on the tokens 300, selected keywords, historical data, purchase logs, online information, proprietary databases, user location, etc. which domain name extensions should be used for the suggested domain names 901. (Step 1060) As an example, the created domain names in FIG. 9 assume that the domain name extensions “.com,” “.food,” and “.local” where selected by the user or determined by the server 103.

Spin Name Identifiers

The user 100 may provide an indication, using any known, or developed in the future, method that the user 100 wishes to view one or more available name identifiers (such as, as non-limiting examples, domain names or social media handles) based on subcombinations and combinations of the selected tokens 300 and keywords 400. The user 100 may spin, i.e. create a new batch of domain names, preferably after the user 100 has the desired tokens 300, in the desired order, selected the desired keywords, and/or locked the desired tokens 300/keywords as many times as desired. As one non-limiting example, the user 100 may select a “Spin Domain Names” 460 button when ready to spin for more domain names. (Step 1050)

A plurality of name identifiers, such as domain names or social media handles, may be created by concatenating various subcombinations and combinations of the tokens 300, the selected keywords 400, and/or the selected or determined domain name extensions. (Step 1080)

In a preferred embodiment, only one token 300 or keyword 400 from each list is used in a single domain name or social media handle. This helps prevent two or more synonyms appearing in the same name identifier. Another option is to allow only one synonym (even if the synonyms appear from different token lists) in the same name identifier. This option can include considering domain name extensions in the synonym analysis, i.e. a token or keyword that is a synonym of a domain name extension would not be used in the same domain name with the domain name extension. (Step 1070) The non-used synonym token(s), keyword(s), and/or domain name extension(s) may still be used in different domain names, just not together in the same domain name or social media handle.

Control Order of Tokens in Suggested Name Identifiers

Another option is to retain the order of the tokens 300 and keywords 400 in the created domain names or social media handles. As an example, the order of the tokens 300 in FIG. 8, from left to right, is “Ice Cream” 301, “Factory” 302, “Homemade” 305, and “Local” 306. Thus, the token “Ice Cream” 301 would never appear to the right in a suggested name identifier of the tokens 300 “Factory” 302, “Homemade” 305, or “Local” 306 while “Factory” 302 would never appear to the right in a suggested name identifier of the tokens 300 “Homemade” 305 or “Local” 306. This left to right ordering would apply to all the tokens 300 and selected keywords 400. This embodiment allows the user 100 a great deal of control over the order of the tokens 300 and keywords 400 in the suggested name identifiers 910.

Check Availability of Name Identifiers Before Displaying

After the plurality of name identifiers has been created, each name identifier may be checked, such as by checking with the Registry 107 or social media platform, comparing the name identifier against recent zone files, or by other known, or developed in the future, methods to see if each name identifier is available for registration. Unavailable name identifiers may be removed from the plurality of created name identifiers since these name identifiers would only obscure the presence of available name identifiers and confuse the user 100. (Step 1090)

The created available name identifiers 910 may be prioritized. Names identifiers 910 that are thought to be more valuable or higher quality (generally shorter and more general domain names or social media handles) may be displayed more prominently, such as at the beginning of a list. The name identifiers 910 may also be prioritized based on the order of the tokens 300 and keywords 400, with tokens 300 and keywords 400 to the left having a higher priority than tokens 300 or keywords 400 to the right. (Step 1100)

The created available name identifiers 910 (in this case domain names) may be displayed as shown on webpage 104 in FIG. 9. In this example, the domain name extensions “.com,” “.food,” and “.local” have been selected. The domain names 910 in FIG. 9 are shown for illustrative purposes and have not actually been checked for availability like the domain names would be in a preferred embodiment. (Step 1110)

The user 100 may indicate on the webpage 104 that the user 100 desires to register zero or more of the displayed name indicators 910. In FIG. 9, each displayed domain name is provided a check box, but any known, or later discovered, method for selecting items in one or more lists may be used by the user 100 to select zero or more name identifiers 910. (Step 1120) The user 100 may also return to a webpage 105 that allows further modifications of the tokens 300 and keywords 400 by any known, or developed in the future, method of moving between webpages 105 of a website 104. As an example, the user 100 may select the “Modify Token” 920 button to return to a webpage 105 that allows the user 100 to make further modifications to the tokens 300 and keywords 400.

If the user 100 has indicated that the user 100 would like to register one or more of the domain names 910, the selected domain names may be register to the user 100 over the computer network 102 with a Registry 107. (Step 1130) In the non-limiting example provided in FIG. 9, the user 100 may select a domain name by placing an X in the box next to the domain name and then selecting the “Register Domain Name(s) 900 button. In the example, the domain name “Ice CreamHomemade.com” is selected, but any number of different domain names may be selected using this method. The additional steps in registering the selected domain name(s) with a Registry 107 are well known (such as getting the contact and payment information of the user 100) and will not be discussed to avoid obscuring the invention with these well known processes. A similar process may be used to register a social media handle with a social media platform.

Whether or not the user 100 registers one or more name identifiers 910, the user 100 may return to the webpage 105 shown in FIG. 8 to make further modifications to the tokens 300 and the selected keywords 400. This allows the user 100 to easily create and see, i.e. spin, many more available name identifiers merely by making adjustments to the selected tokens 300 and keywords 400. This process has the advantage over previous methods by removing the step of forcing the user 100 to reenter the user search 201 prior to every name identifier search. This powerful process allows the user 100 to easily zero-in on the best possible name identifier for the user 100.

Positioning Suggested Domain Name(s)

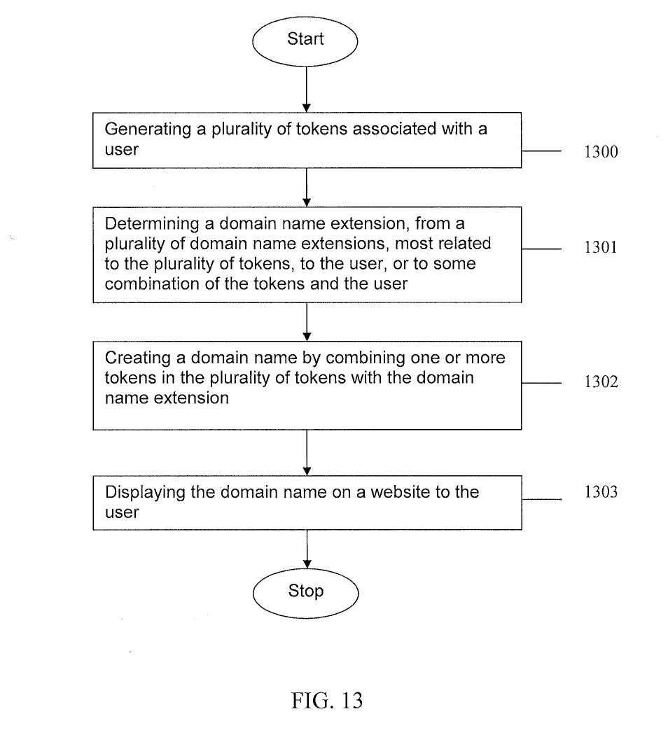

Another embodiment will now be discussed with reference to FIG. 13. In this embodiment, a plurality of tokens 300 associated with a user 100 may be generated by any method or as disclosed above. (Step 1300) As specific, non-limiting examples, the tokens 300 may be generated from a user search 201, from public and/or private information associated with the user 100, from experimental or frequently selected tokens 300, from a keyword spinner and/or synonyms/related words to any of the above.

The most closely related domain name extension to the plurality of tokens 300 may be determined. (Step 1301) The Internet Corporation for Assigned Names and Numbers (ICANN) defines policies that control domain name extensions. While the number of domain name extensions is growing (there are currently over 300), the number of domain name extensions is finite. Those familiar with the art will know how to find domain name extensions that are recognized by ICANN. While the invention may be used with all the domain name extensions recognized by ICANN, some embodiments may only operate on a subset of domain name extensions.

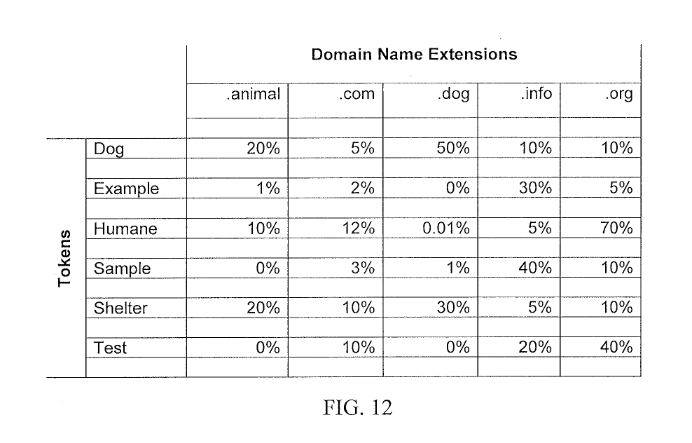

FIG. 12 represents, as a non-limiting example, a database that may be used to practice the invention. A database is an organized collection of data. The data are typically organized to model relevant aspects of reality in a way that supports processes requiring this information. Database management systems (DBMSs) are specially designed applications that interact with the user 100, other applications, and the database itself to capture and analyze data. A general-purpose database management system (DBMS) is a software system designed to allow the definition, creation, querying, update, and administration of databases. As non-limiting examples, DBMSs may include MySQL, MariaDB, PostgreSQL, SQLite, Microsoft SQL Server, Oracle, SAP, dBASE, FoxPro, IBM DB2, LibreOffice Base and FileMaker Pro.

The data in FIG. 12 reflects an illustrative sample of a plurality of domain name extensions (.animal, .com, .dog, .info, and .org) with a corresponding determined amount of relatedness for each token with an illustrative sample of a plurality of tokens 300 (Dog, Example, Humane, Sample, Shelter, and Test). Of course in practice, any number and combination of domain name extensions and tokens 300 may be used and will generally contain much more data. The small database shown in FIG. 12 is shown for illustrative purposes only, and actually databases will generally be much larger.

The terms related and relatedness should be construed broadly and mean a compatibility, similarity, affinity, high frequency of appearing together, and/or association in some manner. While the relatedness data in the database illustrated in FIG. 12 is stated as a percentage, the invention is not so limited and any quantitative or other type of scale may be used to indicate different levels of relatedness.

In one embodiment, the relatedness of the tokens 300 to the domain name extensions are determined by parsing all past registered domain names (or domain names registered within a given time period, preferably over a recent time period to keep the data relevant with current trends) and comparing the frequency a given token in a registered domain name is found with a particular domain name extension. Tokens 300 frequently found with a particular domain name extension are preferably assigned a high relatedness for that domain name extension, while tokens 300 infrequently found with the particular domain name extension are preferably assigned a low relatedness for that domain name extension. The results of the parsing of the domain names may be scaled and/or normalized before saving in a database, such as that shown in FIG. 12.

In addition to past registered domain names, other databases may be scanned to determine the relatedness of particular tokens 300 to domain name extensions.

Also, while the database in FIG. 12 illustrates only tokens 300 that are single words, the database is not so limited, and may also include tokens 300 that comprise a plurality of words, entities, and/or n-grams. Further, while the database may be used to rapidly determine a relatedness of tokens 300 to domain name extensions, other embodiments permit the invention to calculate a relatedness of one or more tokens 300 to one or more domain name extensions in real time.

As specific examples from the database illustrated in FIG. 12, the token “Dog” has been determined to be related to the domain name extension “.animal” by 20%, “.com” by 5%, “.dog” by 50%, “.info” by 10%, and “.org” by 10%. Each of the other tokens 300, i.e., “Example,” “Humane,” “Sample,” “Shelter,” and “Test” are also provided a percentage of relatedness for the same list of domain name extensions.

A plurality of domain name extensions may be ranked for a given one or more tokens 300 using any mathematical technique. As non-limiting examples, the plurality of domain name extensions may be ranked by adding, averaging, or accepting the highest relatedness for each of the one or more tokens 300 for each domain name extension in the plurality of domain name extensions.

As an example, the tokens 300 “Humane” and “Shelter” may have been generated for a user 100. Using the data in FIG. 12, tokens 300 “Humane” and “Shelter” may be determined to have a relatedness for the domain name extension “.com” to be “Humane” 12%+“Shelter” 10%=22%. The tokens 300 “Humane” and “Shelter” may be determined to have a relatedness for the domain name extension “.dog” to be “Humane” 0.01%+“Shelter” 30%=30.01%. Thus, for the tokens 300 “Humane” and “Shelter,” the domain name extension .com has a relatedness of 22% while the domain name extension .dog has a relatedness of 30.01%. In this example, the domain name extension .dog (30.01%) would be ranked higher than the domain name extension .com (22%). While the relatednesses were added in this example, other methods may also be used. A plurality of domain name extensions may be ranked in this manner based on the calculated relatedness of the tokens 300 for each domain name extension in the plurality of domain name extensions.

Not only can domain name extensions have a relatedness for a token or a plurality of tokens 300, but domain name extensions can also have a relatedness to a user 100. The relatedness of one or more domain name extensions to the user 100 may be determined using any method of determining relatedness and, for illustrative purposes, may be determined by using one or more of the following examples and factors.

As a non-limiting example, the current location of the user 100, billing location, or any other location information associated with the user 100 (location factors) may be used to determine the relatedness of one or more domain name extension to the user 100.

As another non-limiting example, categories or fields of interest (e.g., automobiles, botany, child development, history, religion, rifles or self help), hobbies (e.g., astronomy, cooking, chess, crochet, gardening, hunting, photography, sports, stamp collecting or wood working), professions (e.g., accountant, attorney, agriculture, auto repair, civil engineer, construction, dentil, graphical designer, medicine, mining, psychology or teacher/professor), category/vertical of business (e.g., architect, fast food, house cleaning, manufacturer or real estate) or expertise (e.g., computer programming, mathematics, metallurgy or website designer) of the user 100 may be used to determine the relatedness of one or more domain name extensions to the user 100.

As another non-limiting example, a domain name extension's relevance to the user 100 (e.g., such as to the location of the user 100, interest of the user 100, hobbies of the user 100, profession of the user 100, business of the user 100, and/or expertise of the user 100) may be used to determine the relatedness of one or more domain name extensions purchased by the user 100.

As another non-limiting example, business factors, such as the number of years for registration of domain name extensions or that increase domain name registrations and/or customers may be used to determine the relatedness of one or more domain name extensions to the user 100.

As another non-limiting example, site factors, such as which site the user 100 is currently using and/or has used in the past may be used to determine the relatedness of one or more domain name extensions to the user 100.

As another non-limiting example, pricing factors, such as current price, sale price, renewal price, etc. may be used to determine the relatedness of one or more domain name extensions to the user 100.

As another non-limiting example, the user's 100 preference, implicit and/or explicit, such as those determined from past purchases and/or browsing behaviors, or past purchases and/or browsing behaviors from users similar to the user 100 may be used to determine the relatedness of one or more domain name extensions to the user 100.

As another non-limiting example, social factors, such has social media handles' availability for combinations of tokens 300 with the domain name extensions, may be used to determine the relatedness of one or more domain name extensions to the user 100.

As another non-limiting example, traffic factors such as Search Engine Optimization (SEO), Search Engine Marketing (SEM), CPM rates (Cost per 1000 impressions of advertising displayed on the domain name), etc, may be used to determine the relatedness of one or more domain name extensions to the user 100.

Another way for domain name extensions to improve their ranking is to receive a payment to rank a particular domain name extension higher within a plurality of domain name extensions.

While a plurality of domain name extensions may be ranked based solely on a payment for ranking, solely on a relatedness to generated tokens 300, or solely on a relatedness to a user 100, in a preferred embodiment, two or more of these factors are blended together to rank the plurality of domain name extensions. These factors may be normalized, added, averaged, combined, merged, and/or weighted. The weighting of one or more of these factors allows some of these factors to be more or less determinative (based on the weighting) to the ranking of the plurality of domain name extensions than other factors.

Another exemplary method is disclosed in FIG. 13 for suggesting a domain name on a website 104 for a user 100 to register. The domain name or domain name extension selected for suggesting to the user 100 may be based on the relatedness of the domain name's corresponding domain name extension with one or more tokens 300, with the user 100, or some combination of relatedness to the tokens 300 and the user 100. In this embodiment, a plurality of tokens 300 may be generated that are associated with a user 100. (Step 1300) A plurality of domain name extensions may be analyzed to determine the domain name extension that is most related to the plurality of tokens 300, to the user 100, or to some combination thereof. (Step 1301) A domain name may be created by combining one or more tokens 300 in the plurality of tokens 300 with the domain name extension that is most related to the plurality of tokens 300, to the user 100, or to some combination thereof. (Step 1302) The domain name may then be displayed on the website 104 for the user 100 to select at the user's 100 discretion. (Step 1303) The selected domain name may be registered to the user 100.

This embodiment may also allow the user 100 to manipulate the tokens 300 on the website 104. In addition, the availability of the domain name may be checked and only displayed on the website 104 to the user 100 if the domain name is available for registration.

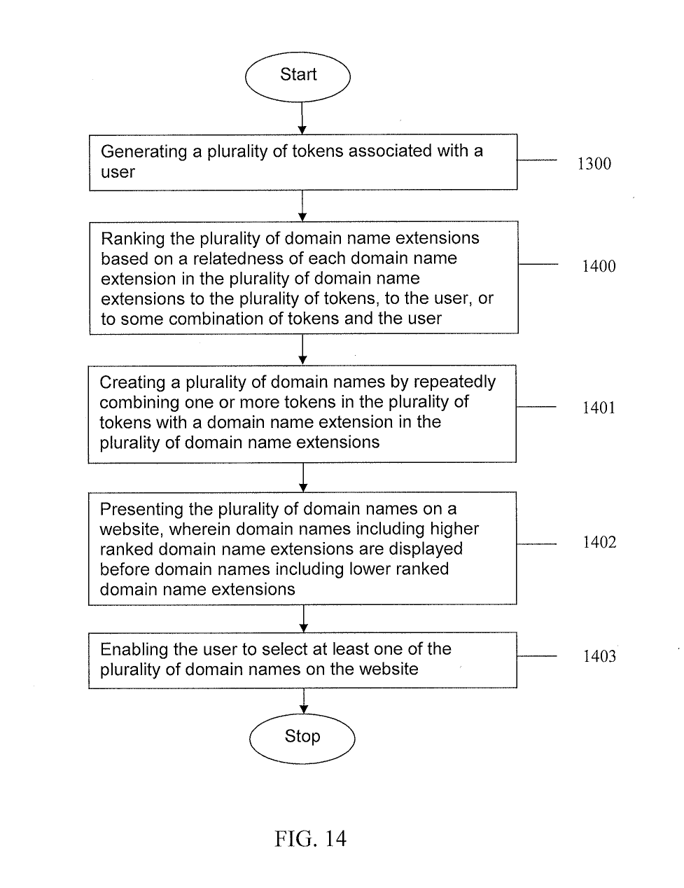

Another exemplary method is disclosed in FIG. 14 for positioning suggesting domain names on a website 104 for a user 100 based on the relatedness of the domain names' corresponding domain name extensions with one or more tokens 300, with the user 100, or with some combination thereof. In this embodiment, a plurality of tokens 300 associated with the user 100 may be generated. (Step 1300) A plurality of domain name extensions may be ranked based on a relatedness of each domain name extension with the plurality of tokens 300, with the user 100, or some combination thereof. (Step 1400) A plurality of domain names may be created by repeatedly combining one or more tokens 300 in the plurality of tokens 300 with a domain name extension in the plurality of domain name extensions. (Step 1401) Preferably, only top ranked domain name extensions are used to create the plurality of domain names. The domain names that have higher ranked domain name extensions may be presented to the user 100 on the website 104 before domain names that have lower ranked domain name extensions. (Step 1402) The user 100 may then select on the website 104 one or more of the presented domain names for registration. (Step 1403)

As in prior embodiments, this embodiment may also allow the user 100 to manipulate the tokens 300 on the website 104. In addition, the availability of the created domain names may be checked prior to being displayed, and only the available domain names are displayed on the website 104 to the user 100 for registration.

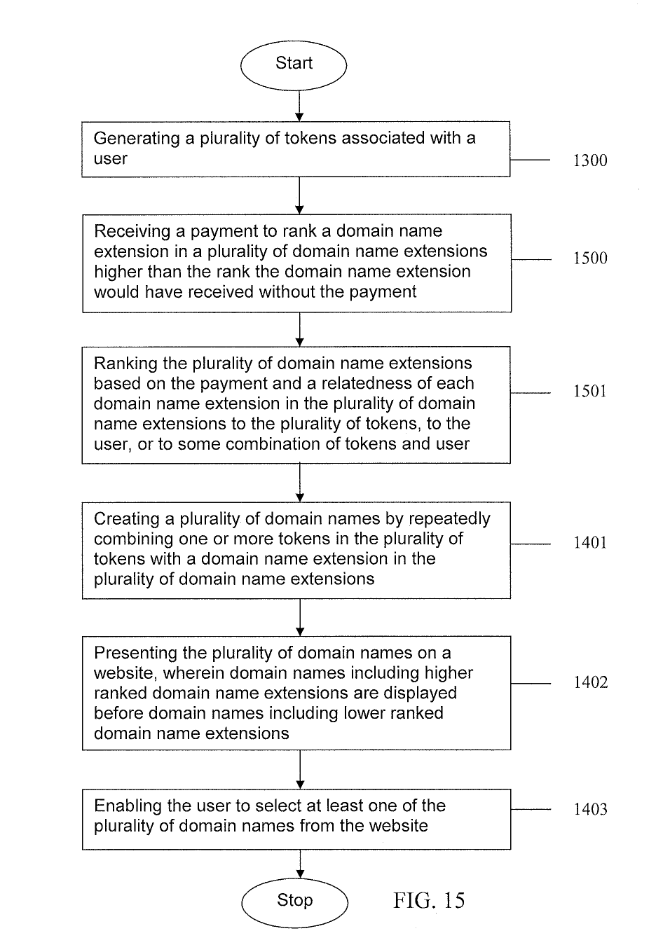

Another exemplary method is disclosed in FIG. 15 for positioning suggested domain names 901 on a website 104 for a user 100 based on a payment received and/or a relatedness of the domain names' corresponding domain name extensions with one or more tokens 300, with the user 100, or some combination thereof. Domain names that have been at least partially ranked based on a received payment may be presented to the user 100 on the website 104 in the same manner as domain names that have not been ranked based on a received payment. However, in a preferred embodiment, domain names that have been at least partially ranked based on a received payment are presented to the user 100 on the website 104 in a different manner than domain names that have not been ranked based on a received payment. For example, the font type, font size, font color, font style, font background, font highlighting, font positioning, or any other user interface change on the website 100 may be used to distinguish domain names that have been at least partially ranked based on a received payment from domain names that have not been ranked based on a received payment.

In embodiments that include a received payment, a plurality of tokens 300 associated with a user 100 may be generated. (Step 1300) A payment to alter the ranking of a domain name extension, in the plurality of domain name extensions, may be received. (Step 1500) The plurality of domain name extensions may be ranked based on the payment received and/or the relatedness of each domain name extension with the plurality of tokens 300, with the user 100, or some combination thereof. (Step 1501) A plurality of domain names may be created by repeatedly combining one or more tokens 300 in the plurality of tokens 300 with a domain name extension in the plurality of domain name extensions. (Step 1401) Preferably, only top ranked domain name extensions are used to create the plurality of domain names. The domain names that have higher ranked domain name extensions may be presented to the user 100 on the website 104 before domain names that have lower ranked domain name extensions. (Step 1402) The user 100 may then select on the website 104 one or more of the suggested domain names 910 for registration. (Step 1403)

This embodiment may also allow the user 100 to manipulate the tokens 300 on the website 104. In addition, the availability of the created domain names may be checked prior to being displayed, and preferably only the available domain names are displayed on the website 104 to the user 100.

Positioning Suggested Domain Names Based on Term Frequency and/or Term Co-Occurrence.

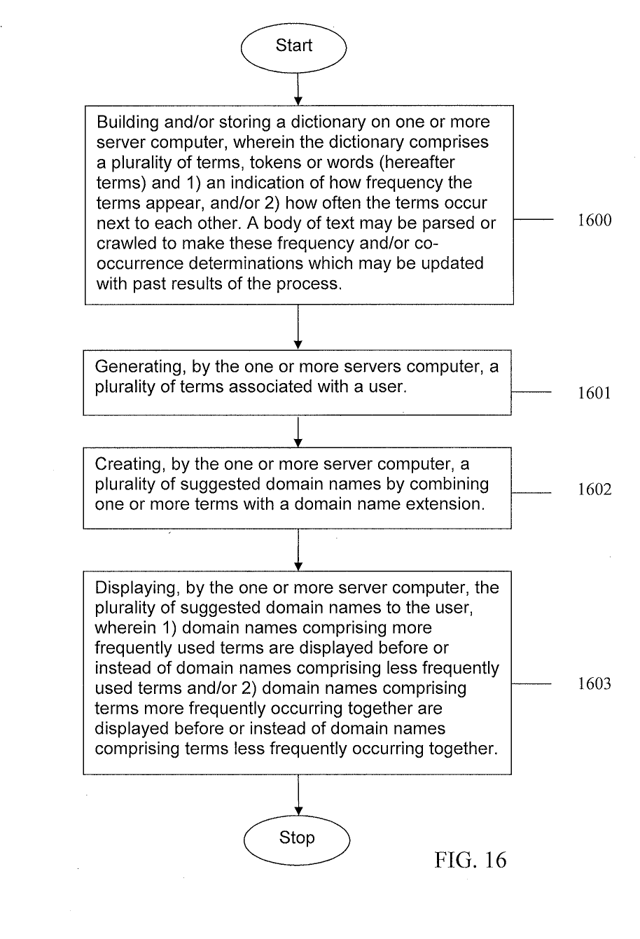

Another embodiment is illustrated in FIG. 16. In this embodiment various entity sources and/or one or more bodies of text (e.g., domain name search/selection and/or registration logs, search engines request logs, Wikipedia, standard language dictionaries, websites, external sources and/or databases, etc.) may be crawled to compile a list of words, terms and/or phrases (hereafter terms) that comprise new, unfamiliar, product-specific (e.g., “kindle,” “iPad”) terms or that occur together (e.g., “mickey mouse,” “ice cream,” etc.) These frequently used and/or co-occurring terms may be stored as a language dictionary that compiles the terms that may be stored in a database. How frequently these terms appear within a text body, selected and/or registered domain names and how frequently two or more of these terms appear together (co-occurrence) in a text body or in selected and/or registered domain names may also be stored in the dictionary.

A single dictionary may cover different markets, countries and/or languages or a plurality of dictionaries may be used, with each dictionary representing a different market, country and/or language. Any number of dictionaries may be used with each dictionary directed towards any number of different markets, countries and/or languages.

A co-occurrence pair of terms may have a different score and/or rank in different markets, countries and/or language dictionaries. For example, the terms “Mickey” and “mouse” may have a high score in an English dictionary and a low score in a Russian dictionary, while “Mikki” and “maus” may have a high score in a Russian dictionary and a low score in an English dictionary.

Similarly, the score and/or rank for the same pair may be different in different markets. For example, the terms “taxi” and “limo” may be ranked high in a United States dictionary and low in a United Kingdom dictionary, while “taxi” and “car” may be ranked lower in the United States dictionary, but higher in the United Kingdom dictionary.

The dictionary is preferably designed for domain name spinning rather than for general purposes (e.g., English language dictionary). Terms within the dictionary may be “specialized,” that is associated in the database with variants for markets (e.g., brands), countries and/or languages (e.g., UK, US, Australian English). Languages, countries and markets may be determined via IP addresses, domain string requested, etc. The terms may also be used to select domain name extensions. (Step 1600)

A server computer running appropriate software to create a webpage on a website may receive a query string from a user as previously described with reference to FIG. 2. As non-limiting examples, the server computer may receive “mickeymouseicecream,” “michaelicefactory,” or “kindlebooksstarwars.”

The server computer may identify one or more terms in the received query string. For example, the query string “michaelicefactory” may be parsed and one or more terms in the dictionary may be identified. Specifically, michae (start 1, length 6), michael (start 1, length 7), lice (start 7, length 4), ice (start 8, length 3), fact (start 11, length 4) and factory (start 11, length 7) may all be found. In addition, terms associated with the user may be determined as previously described. (Step 1601)

A finite state machine, consisting of a graph, may compare the received string with comparable data from the dictionary. In the “mickeymouseicecream” example, “m” is the root path, with nodes for “i,” “c,” “k,” “e,” “y,” etc. As long as the language dictionary has a comparable path (e.g., “m,” “i,” “c,” “k,” “e,” “y,” etc.), the state machine continues. When the state machine identifies a recognized word (e.g., “mickey”), the state machine may use the following letter (e.g., “m”) to determine whether to continue. As another example, perhaps the next letter after “mickey” is “e”. If the dictionary has a node to “eye,” the state machine may continue to determine if “eye” is the next term after “mickey.” If the state machine does not find an “m” or “e” after “mickey” in the received string (or any other letter that has a node attached after “mickey”), the state machine may stop at this point and identify “mickey” as a term.

As more and more sources are added to the dictionary, more options may be available after the “y” in “mickey”. The state machine may also determine “strong” (i.e., higher probability matches) nodes after completed words (e.g., “m” for “mouse” is probable after “mickey,” “k” for “kangaroo” is much less probable). The state machine may determine that the stronger the node, the more likely that the two words belong together in suggesting domain names. Thus, domain names with stronger nodes are shown more prominently, before or instead of domain names with weaker nodes in a domain name suggestion list.

The server computer may generate a preliminary list of tokenization variants (e.g., list one—“micahae,” “lice,” “factory;” list two “michae,” “lice,” “fact,” “ory;” list three—“michael,” “ice,” “factory;” and list four—“michael,” “ice,” “fact,” “ory,” etc.) A simple term frequency may be used in this example to determine that the tokens “michael” and “ice” are more probable than “michae” and “lice”, since “michae” would show up infrequently in the dictionary.

Additional sources may also be used to determine frequency and/or co-occurrence, including search engine request logs, Wikipedia titles, people names (census data), product names (e.g., Kindle), city names, etc. Identified dictionary entries may be stored in the database along with an indication of the terms frequency of use and co-occurrence with other terms.

As queries are received, the server computer determines preferred terms (from the dictionary and/or database) using term frequency, as described above and/or co-occurrence of terms. The server computer may also identify terms/words that are more likely to appear together. The server computer may then analyzes co-occurrence of terms within the user query to determine preferred terms (e.g., “mickey mouse” vs. “mickey rat” and “kindle” vs “kind le”) and boost bi, tri and/or n grams in the language dictionary and/or list of terms.

The server computer may rank the variants and terms according to a score indicating a probability of intended meaning by the user. The score may be based on term frequency and/or co-occurrence of terms as described above.

As more information is compiled, frequency (e.g., how frequently a term is used) and co-occurrence information (e.g., how frequently do terms appear together) may also come from user feedback loops (e.g., how frequently do users select domain names that comprise the terms?). This information may continue to be stored in the dictionary on the database. A plurality of suggested domain names may be created, preferably with terms with a high frequency of use and/or co-occurrence of terms either within a text body or as part of a previously selected and/or registered domain name. (Step 1602)

The user may be presented with a plurality of suggested domain names, possibly based on their query, ranked according to scores of term frequency and/or term co-occurrence (e.g., “kind,” “le,” “books,” “star,” and “wars” vs. “kind,” “le,” “book,” “star,” and “war,” vs “kindle,” “books,” “star,” “wars”). (Step 1603)

The server computer may discover or identify a “new” term (e.g., “kindle” or “ipad”). The server computer may receive feedback on the new term (e.g., user clicks on “kindle” or selects the suggested domain name variant spin with “kindle”).

The server computer may “promote” terms and/or variants within a selected domain name with a higher score or rank in the dictionary stored in the database (e.g., “kindle” is promoted and receives a higher score result in the dictionary stored in the database if “kindle” is part of a selected and/or registered suggested domain name.)

The server computer may “demote” terms and/or variants with a non-selected and/or non-registered domain name with a lower score or rank in the dictionary stored in the database (e.g., “kindle” is demoted and receives a lower score result in the dictionary or database if “kindle” is part of an unselected domain name.)

Search logs, dictionaries and/or databases may be updated to reflect the higher or lower scoring or ranking of terms in selected and unselected suggested domain names. Subsequently the server computer may intelligently determine which combinations and/or new terms are being selected by users and score or rank them higher.

Suggested domain names with higher ranking terms based on the frequency of their use, purchase probabilities or their co-occurrence with other terms may be given priority and shown more prominently, instead of and/or before suggested domain names with lower ranking terms.

In some embodiments, “discovered” terms (possibly with a large flux of new or combined terms) may be included to see if users will select them thereby generating higher scores and making the system more intelligent over time. The server computer can either flag these terms for review or the terms can be automatically added to the dictionary stored on the database.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. As examples, while the invention has been described in detail for spinning domain names, the invention may also be used to spin name identifiers in other fields. As specific non-limiting examples, the invention may also be used to spin name identifiers for license plates, phone numbers and social media name identifiers.

Completing Domain Name Searches

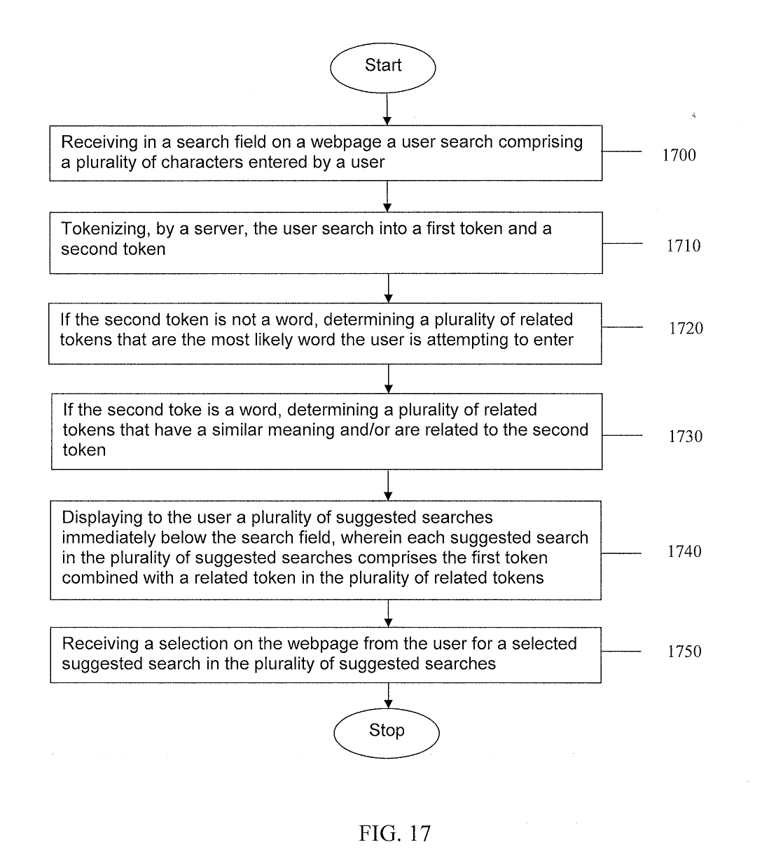

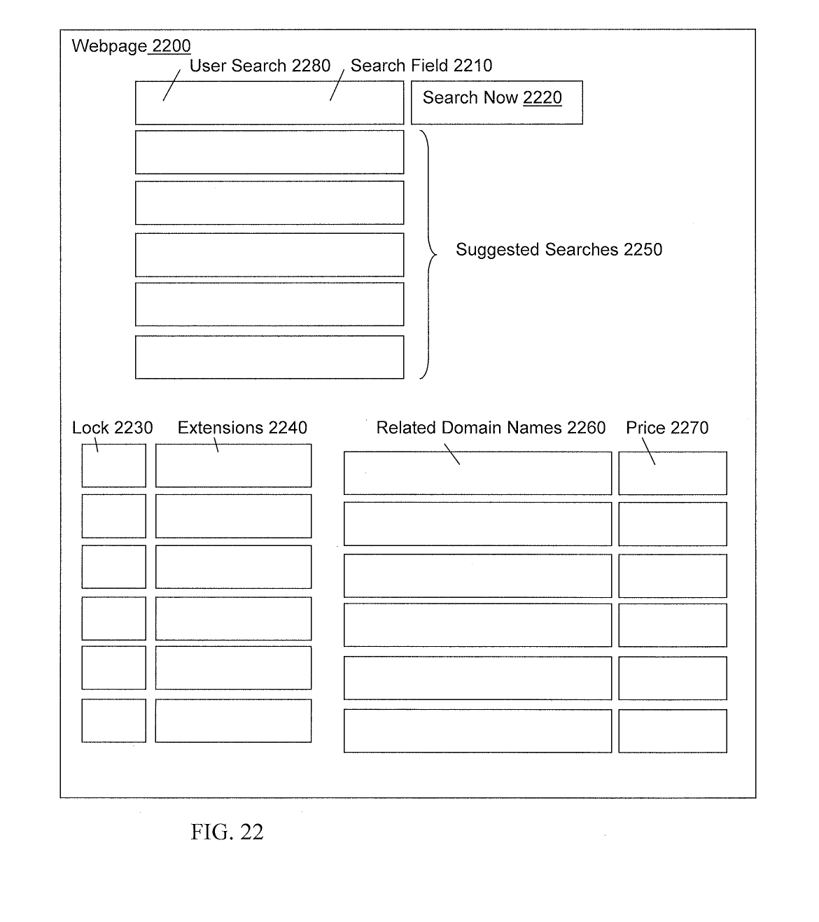

An example method for generating domain name suggested searches 2250 and related domain names 2260 to a selected domain name suggested search is illustrated in FIG. 17. FIGS. 22-25 illustrate a webpage 2200 with a user search 2280 in a search field 2210, a plurality of extensions 2240 and a plurality of related domain names 2260 that may be used as part of this embodiment. The method may start with the user being presented with the webpage 2200 illustrated in FIG. 22. At the start of the method, there is preferably no user search 2280 in the search field 2210, no displayed extensions 2240 and no displayed related domain names 2260.

The user may enter a user search 2280 into the search field 2210 on the webpage 2200. The user search 2280 will typically be entered by the user one character at a time. The backend for the webpage 2200 (comprising one or more servers) may receive the user search 2280 one character at a time as the user enters the user search 2280. (Step 1700)

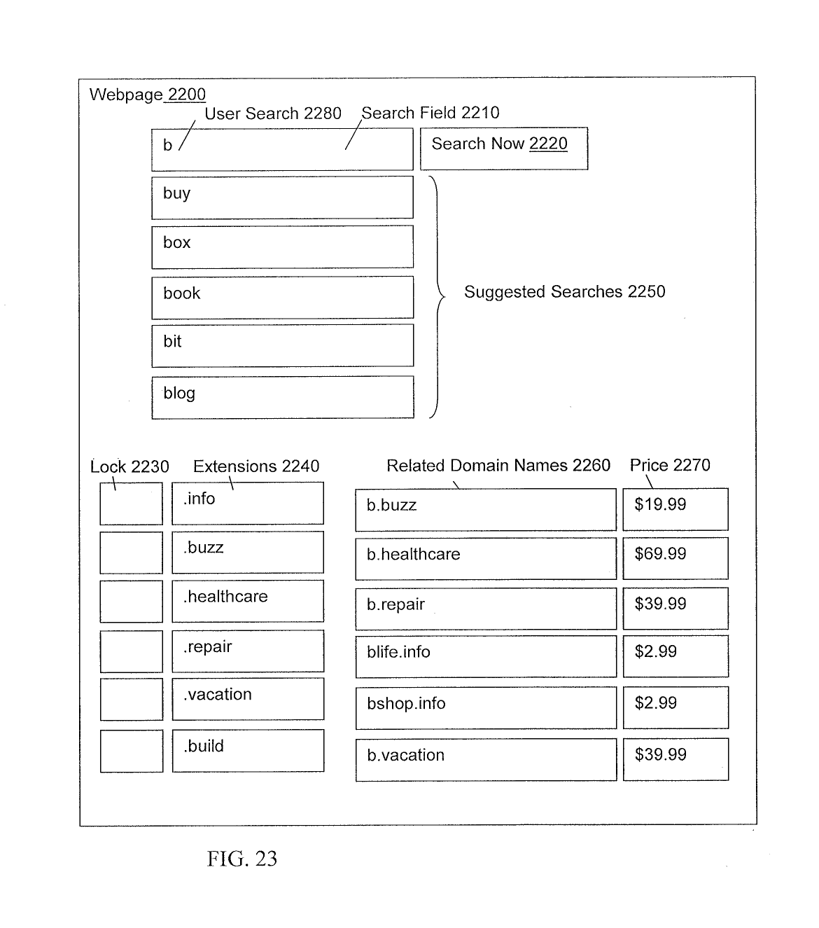

FIG. 23 illustrates an example where the user enters the letter “b” into the search field 2210. Of course, any character(s) and/or number(s) may be entered by the user. The backend for the webpage 2200 may generate and display a plurality of suggested searches 2250 based on the user search 2280. In the example illustrated in FIG. 23, the backend of the webpage 2200 created and displayed the suggested searches 2250 of “buy,” “box,” “book,” “bit” and “blog” based on the user search 2280 of “b.” The suggested searches 2250 may be the most common words or tokens used by the same user and/or other users that have entered the same or similar user searches. It should be appreciated that the user may select one of the suggested searches 2250 displayed on the webpage 2200 at anytime.

The backend for the webpage 2200 may also create and display a plurality of related domain names 2260 (and preferably also displays each domain name's price 2270) based on the user search 2280. In the example shown in FIG. 23, the backend of the webpage 2200 used the user search 2280 of “b” to produce and display the related domain names 2260 (which are preferably screened to make sure the related domain names 2260 are either available for registration or available for purchase) of “b.buzz,” “b.healthcare,” “b.repair,” “blife.info,” “bshop.info” and “b.vacation.” It should be appreciated that the user may select one of the related domain names 2260 for domain name registration on the webpage 2200 at anytime.

The backend for the webpage 2200 may also select and display a plurality of extensions 2240 (also known as top-level domains) based on the user search 2280. In the example shown in FIG. 23, the user search 2280 of “b” produced the extensions 2240 of “.info,” “.buzz,” “.healthcare,” “.repair,” “.vacation,” and “.build.” If an extension is selected by the user, then all of the related domain names 2260 that are displayed on the webpage 2200 will have that extension. It should be appreciated that the user may select one of the displayed extensions 2240 (in the illustrated example, the user may check the lock 2230 box across from the desired extension) on the webpage 2200 at anytime.

In some embodiments the suggested searches 2250, extensions 2240 and related domain names 2260 are updated every time the user enters a new character of the user search into the search field on the webpage.

In other embodiments, only the suggested searches 2250 are updated every time the user enters a new character of the user search into the search field on the webpage. In these embodiments, the user may select a Search Now button, as a non-limiting example, to cause the backend of the webpage to update the extensions 2240 and related domain names 2260 based on the current user search or the selected suggested search. In some embodiments, the extensions 2240 and related domain names 2260 are updated when the user selects one of the displayed suggested searches 2250.

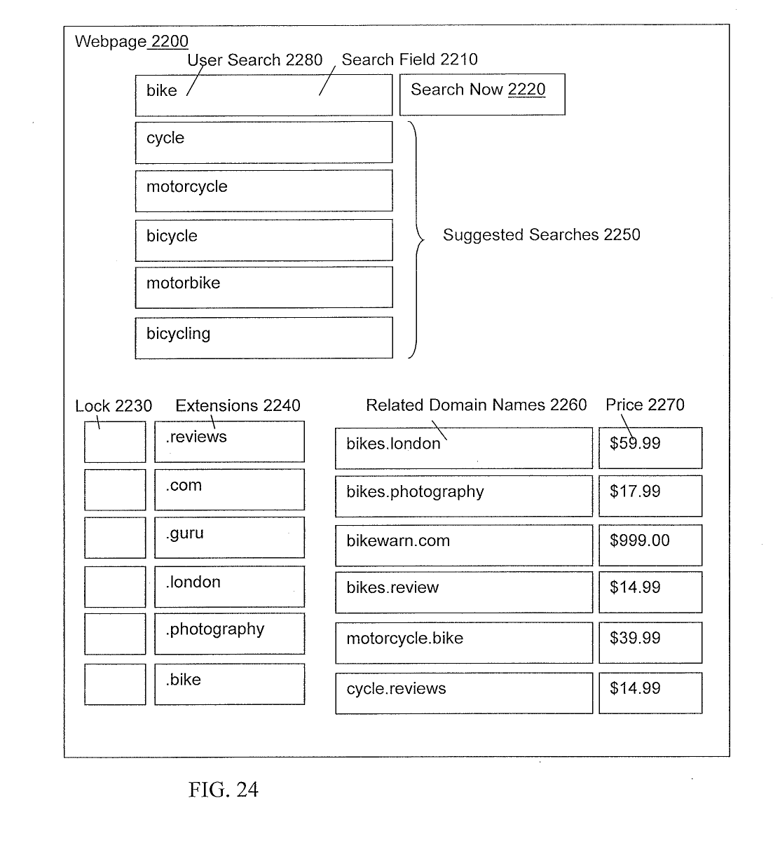

FIG. 24 illustrates an example where the user enters the word/token “bike.” Of course, any word or token may have been entered by the user. The backend for the webpage 2200 may generate and display a plurality of suggested searches 2250 based on the user search 2280. In the example illustrated in FIG. 24, the backend of the webpage 2200 created and displayed the suggested searches 2250 of “cycle,” “motorcycle,” “bicycle,” “motorbike” and “bicycling” based on the user search 2280 of “bike.” The suggested searches 2250 may change as each letter is added to “b” as it becomes “bike.” The backend for the webpage 2200 may consider “bike” a token if it is a word (which “bike” is) and/or is entered into the search field 2210 frequently enough by the user and/or other users. When a first token is found in a user search 2280, the backend may look for synonyms and/or other words or tokens that are related to the first token for display as suggested searches 2250.

The backend for the webpage 2200 may also update and display the plurality of related domain names 2260 as the user search 2280 changes from “b” to “bike” as the user types in additional characters into the search field 2210. In the example shown in FIG. 24 (where the user has entered “bike” into the search field 2210), the backend of the webpage 2200 used the user search 2280 of “bike” to update and display the related domain names 2260 (again, which are verified to be available for registration or purchase) of “bikes.london,” “bikes.photography,” “bikewarn.com,” “bikes.review,” “motorcycle.bike” and “cycle.reviews” (and each domain name's corresponding price 2270).

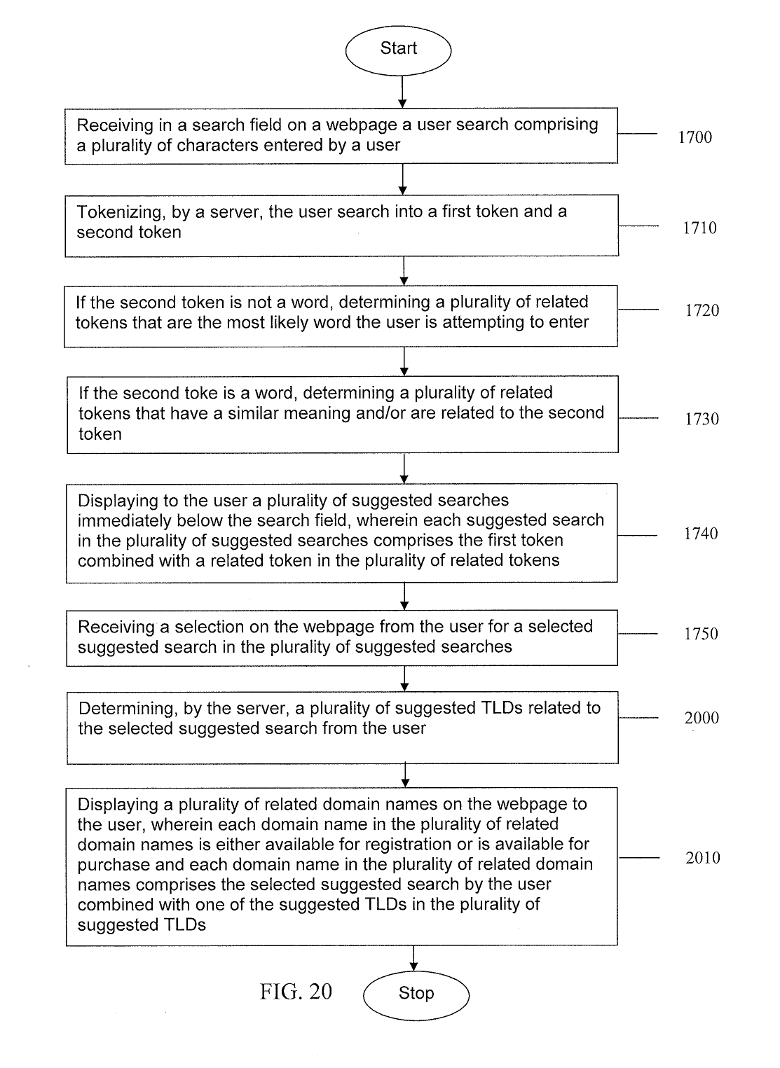

The extensions 2240 may also continue to be updated as the user enters each additional character to change the user search 2280 from “b” to “bike.” In the illustrated example in FIG. 24, the user search 2280 of “bike” caused the extension to change and to display “.reviews,” “.com,” “.guru,” “.london,” “.photography” and “.bike.” (Step 2000 in FIG. 20)

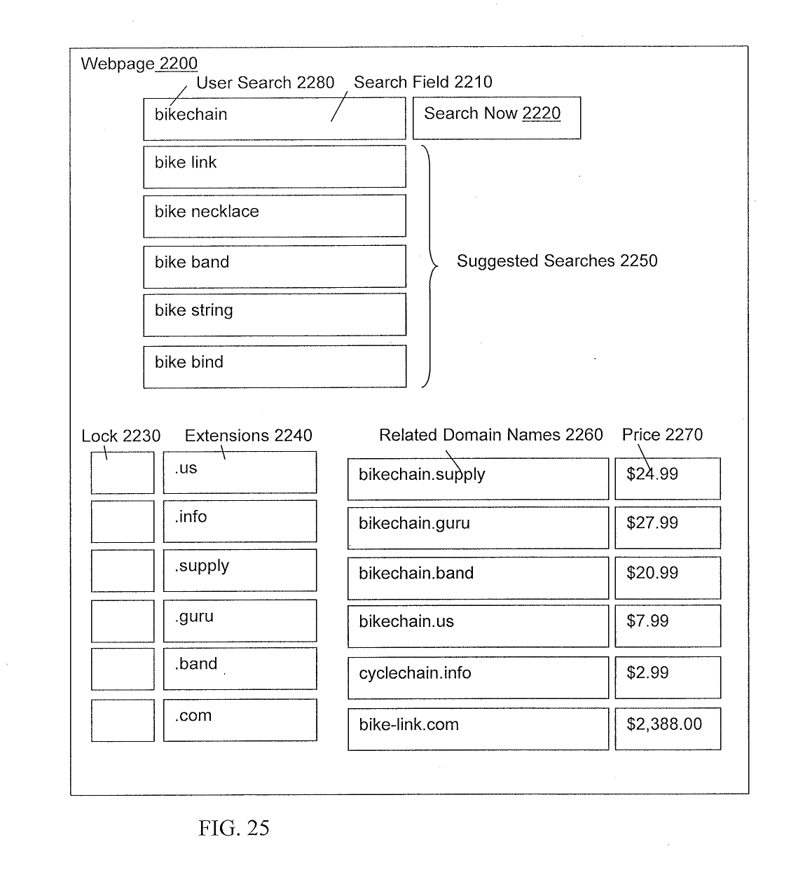

FIG. 25 illustrates an example where the user enters the user search 2280 of “bikechain.” The backend of the webpage 2200 may tokenize this user search 2280 into a first token and a second token. (Step 1710) In this example, the first token may be “bike” while the second token may be “chain.” In preferred embodiments, when there are two tokens, the first token may be “locked” automatically for the user in position and is preferably in all of the displayed suggested searches 2250. The user does not need to take any additional action to lock the first token other than typing in characters that start a second token. In these preferred embodiments, no suggested searches 2250 are shown that do not comprise the “locked” (in this case “bike”) token and the “locked” token (or tokens if multiple tokens are locked) are preferably displayed in the same order as they locked tokens were entered by the user into the search field 2210.

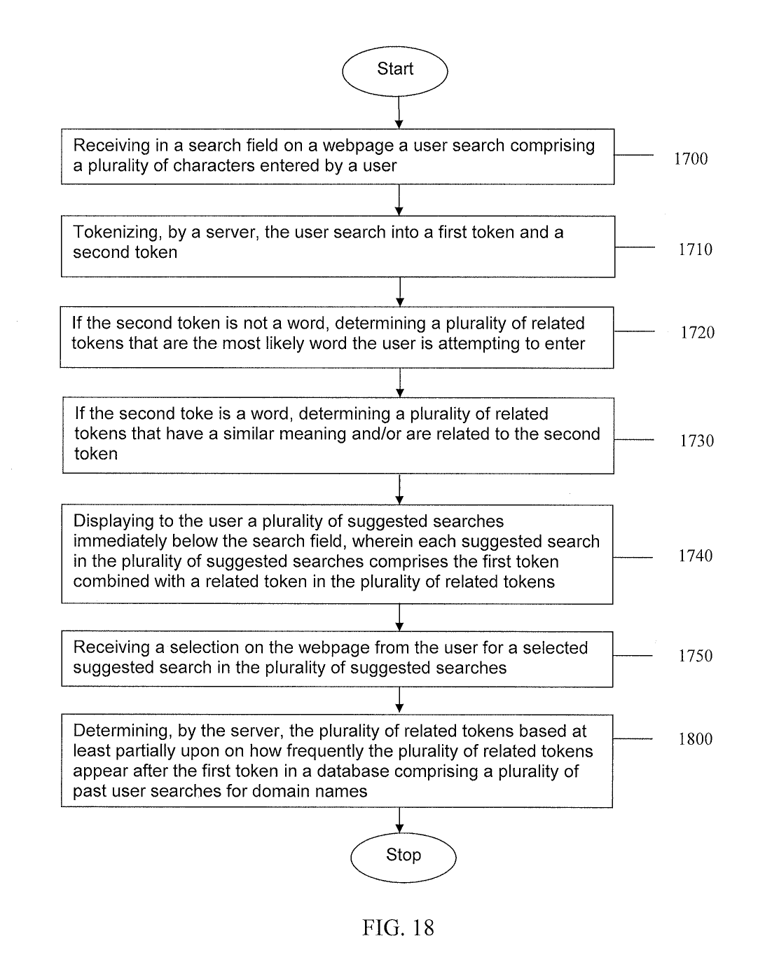

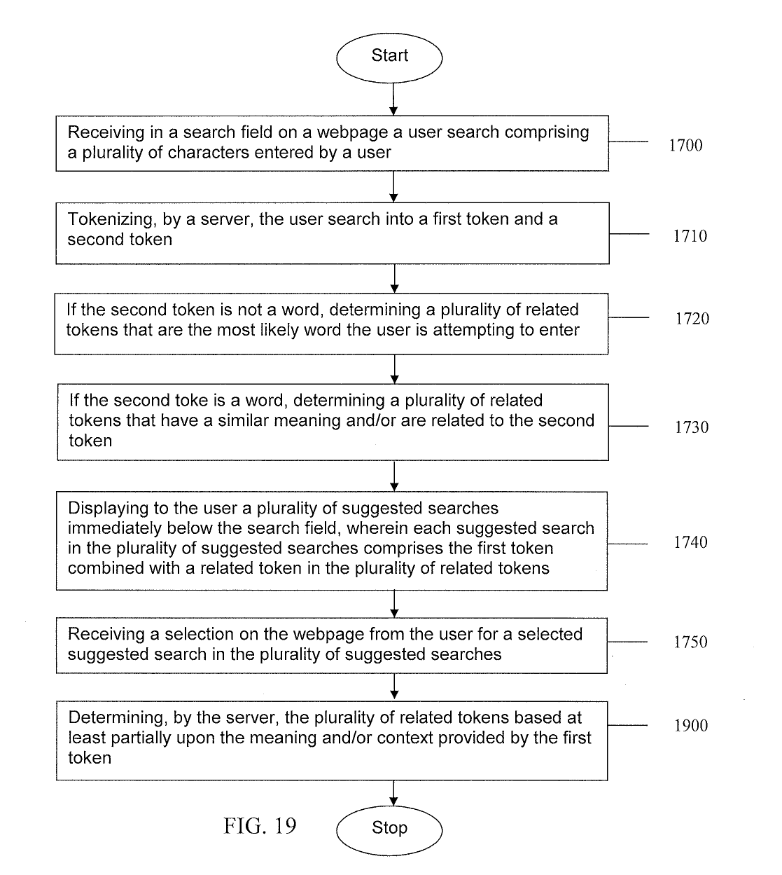

The backend of the webpage 2200 may determine whether the last token is or is not a word. In preferred embodiments, when the last token is not a word the backend of the webpage 2200 determines a plurality of related tokens wherein the plurality of related tokens are the most likely word the user is trying to enter. (Step 1720) When the last token is a word the backend of the webpage 2200 may determine a plurality of related tokens that may either by synonyms and/or related to the second token (Step 1730) and/or are determined to be frequently entered by the same or different users after the first token (Step 1800 shown in FIG. 18) and/or are determined based at least partially upon the meaning and/or context provided by the first (or earlier tokens if multiple tokens were entered by the user) (Step 1900 shown in FIG. 19). A database of user searches for the same and/or different users, synonym dictionaries, and bodies of text may be kept for this purpose. This process will produce suggested searches 2250 that all have the same first token, but that have different second tokens.

The suggested searches 2250 may be displayed to the user on the webpage 2200 immediately below the user search 2280. (Step 1740) In FIG. 25 the suggested searches 2250 of “bike link,” “bike necklace,” “bike band,” “bike string” and “bike bind” are displayed. In preferred embodiments, only suggested searches 2250 that have the locked first token are displayed while synonyms and related words are allowed to “spin” for the second token. The user may continue to enter additional characters to produce additional tokens, select one of the suggested searches 2250 to display a new plurality of related domain names 2260 based on the selected suggested search (Step 1750), lock one of the displayed extensions 2240 so that all displayed related domain names 2260 include the locked extension or select one of the displayed related domain names 2260 to start the registration process for the selected domain name to the user.

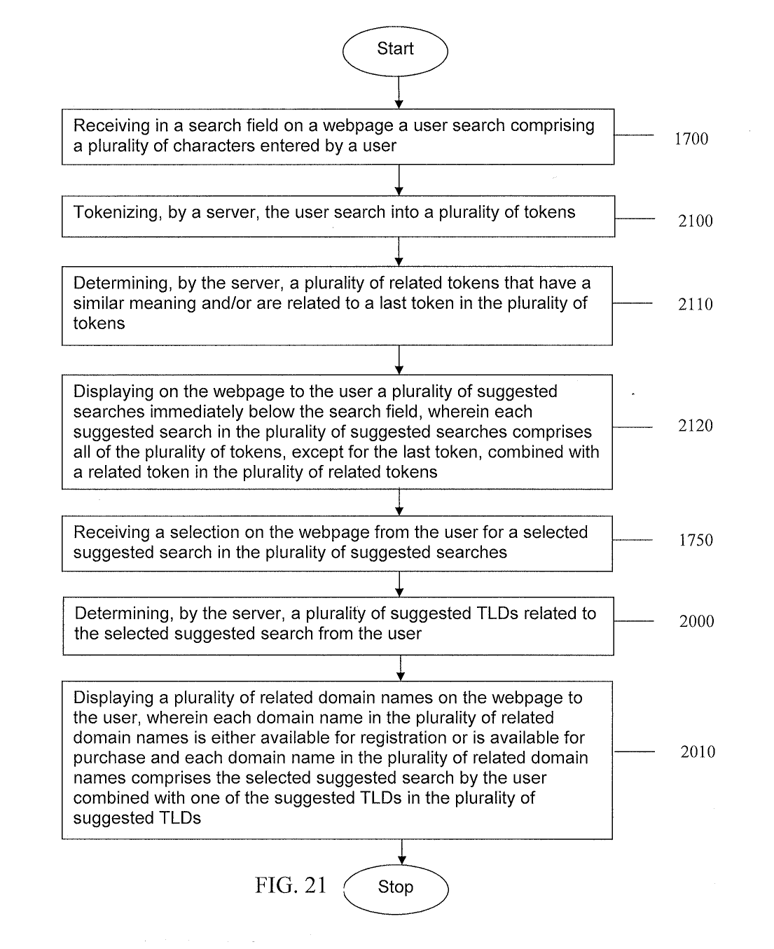

The process may continue as illustrated in FIG. 21. The user may continue to add additional characters into the search field 2210 to allow the backend of the webpage 2200 to create any number of different tokens. (Step 2100) In preferred embodiments, all of the tokens are “locked” in the same order and position as entered by the user except for the last token. The backend of the webpage 2200 may create a plurality of related tokens as previously described for the last token (synonyms, often follows earlier token(s) and/or the context provided by the earlier token(s) and/or the last token). (Step 2110) A plurality of suggested searches 2250 may be created by combining all of the “locked” token(s) (preferably as entered and in the same order) combined with each of the related tokens (one at a time). Each related token (in the plurality of related tokens) may be attached, one at a time, to the end of the locked tokens to create a plurality of suggested searches 2250. In other words, all the tokens are displayed as a suggested search except that the last token is replaced by one of the related tokens. These created suggested searches 2250 may be displayed to the user on the webpage 2200 immediately below the search field 2210. (Step 2120) The displayed suggested searches 2250 may be selected by the user using known or later developed techniques for a user to select of an item (a suggested search) from a group of items (the plurality of suggested searches 2250 displayed as a list immediately below the search field 2210).

In another embodiment, the following process may be performed for every character the user types into the search field 2210 on the webpage 2200. Each character, as entered, may be sent to the backend of the webpage 2200.

The backend for the webpage 2200 may tokenize the typed characters (user search 2280) into one or more tokens. If the tokens obtained are meaningful enough by occurrence count in search logs of prior user searches, the tokenization may be retained. If multiple possible tokenizations are found, the one with the higher occurrence count in search logs is preferably retained. If no tokenization is found to be meaningful enough using occurrence counts, then tokens may be split using spaces (white space), if the user entered any spaces in the user search 2280.

If the last token obtained in this process (assuming two or more tokens have been found) is recognized as a word in an electronic dictionary, then a plurality of synonyms and/or folksonomy alternatives for the last token, may be appended to the end of all of the tokens except for the last token which is replaced by one of the synonyms and/or folksonomy alternatives for the last token. Only synonyms or folksonomy alternatives which pass a threshold relevance score are shown. Folksonomy is a user-generated system of classifying and organizing online content into different categories by the use of metadata such as electronic tags. The use of Folksonomy is discussed in patent application Ser. No. 14/569,348 entitled GENERIC FOLKSONOMY FOR CONCEPT-BASED DOMAIN NAME SEARCHES filed on Dec. 12, 2014 and is hereby incorporated by reference.

If the last token obtained in this process is not recognized as a word in the electronic dictionary, then a plurality of possible completions of the last token may be determined based on past user searches of the user and/or other users. The plurality of possible completions are preferably the most likely possible completions based on the current incomplete (incomplete as determined by not being found in the dictionary) token. For this embodiment, the suggested searches 2250 may comprise all of the tokens as entered by the user except that the last incomplete token may be replaced by one of the possible completions for the last token in the plurality of possible completions.

Adult and/or taboo filtering may be used at this step to remove undesirable search suggests and/or related tokens. The backend of the webpage 2200 may then send the suggested searches 2250 back for display on the webpage 2200 as, in a non-limiting example, a json payload. As previously described, the newly created suggested searches 2250 may be displayed to the user on the webpage 2200 immediately below the search field 2210.

In another embodiment, a method for determining what token (typically a word) is likely to come after another token (also typically a word) may be used. The method may start by determining the probability of the next token given n prior tokens. A statistical language model, per tld, or overall from zone files may be used to generate auto suggested searches 2250, i.e., completion possibilities. Past spins from user search 2280 logs may generate possible extensions 2240 for slds.

The backend of the webpage 2200 may determine whether related domain names 2260 are available or not and only available domain names are preferably presented to the user. A list of available related domain names 2260 may be created. All of the related domain names 2260 may be ranked that are available according to a ranking function, which could be domain name demand or any other function. This may be a hybrid system, in that suggested searches 2250 may be completed in the search field 2210 and/or a list of suggested searches 2250, i.e., auto completions, may also be presented, either as a drop down or as a full page. In preferred embodiments, two modes may be used. In the first mode, before the user types in the dot, the sld may be completed by adding tokens or spinning, which could change prior tokens. In a second mode a user may type in enough tokens or a dot, to complete the tld (the extension). Techniques may be used for determining, without the user typing in the dot, whether it is appropriate to complete the related domain names 2260 with an extension or to add another token. Spinning or changing tokens that a user has already typed in, may happen in the search result/suggested searches 2250 dropdown, rather than changing the user search 2280 in the search field 2210. After the user hit enter, or click search, a full EPP check on the domain name may be done, to verify availability. A time interval of inactivity may also be used as a prompt for a full check. A separate user interface mode may also be used. The extensions 2240 may also be displayed in a dropdown menu, and used as a filter, so that the search field 2210 will complete by using the appropriate ranking and/or language models for that extension only. This will enable a user who is set on buying a particular extension to be displayed on related domain names 2260 that comprise the desired extension. Complex cases which involve extension compaction may also be solved, i.e. if the user types “vegas law firm” the results may be “lawfirm.vegas” as an autocompletion. The user experience (UX) may be adjusted for these cases. The autocomplete for the user search 2280 on incomplete tokens preferably starts after three characters are entered by the user.

Another embodiment for determining a probability for a complete query based on an incomplete token (an incomplete token may be a token not found in an electronic dictionary) or a prefix, i.e., P(complete query|prefix) will now be provided. The backend of the website may tokenize the user search 2280 into one or more tokens. When deciding which combination of tokens most likely represents the user search 2280, the tokenizations that produces words for the tokens before the last token are preferred.

If the last token is a well-defined words, ie, a matching entry may be found in an electronic dictionary, then a synonym dictionary may be checked and a synonym may be used to replace the last token.

If the last token (which may also be the first token if no other tokens have been entered by the user) is not recognized in an electronic database, the last token may be considered a prefix of a to-be-completed word or name. The unrecognized character segments, i.e., the last token, may be looked up to determine what word or token was most commonly used in past user searches by the user and/or past users (based on saved search logs stored in a database) to find a plurality of corresponding complete queries, i.e., the most likely tokens intended by the user based on a partial entry of the last token. A database may be used to store and read user searches from the user and other users to assist in making this determination.

Other embodiments may be referred to as query prefix models. In these embodiments the probability P (complete query|prefix) may be calculated and the top tokens may be used for the suggested searches 2250 for any given prefix.

One method for implementing these embodiments is to tokenize user searches in search logs and zone files. Tokens may be filtered out that are, as non-limiting examples, taboo, adult, racist, drugs, violent, weapons, and/or unrecognized words. For each user search 2280, a cleanup version as a sequence of tokens may be created and stored in the database and used to anticipate the last token if not a word or determine alternatives for the last token if the last token is a word.

In another embodiment, for each user search 2280, all prefixes may be enumerated, together with the complete query and the prefix's query frequency to generate a triple. As a non-limiting examples, the triple of (prefix, query, frequency) may be created as part of the method for determining incomplete tokens.

As an example, given a query of “citybike” seen in a user search log, the following tuples in Table 1 may be generated for an example of tokening “citybike” to “city bike.”

TABLE 1
Tuple Generations

| | | |
|---|---|---|
| c, | city bike, | 1 |
| ci, | city bike, | 1 |
| cit, | city bike, | 1 |
| city, | city bike, | 1 |
| city, | city bike, | 1 |
| city b, | city bike, | 1 |
| city bi, | city bike, | 1 |
| city bik, | city bike, | 1 |
| city bike, | city bike, | 1 |

In some embodiments, the space between tokens may be collapsed to generate additional tuples as shown in Table 2:

TABLE 2
Collapsed Tuple Generations

| | | |
|---|---|---|
| cityb, | city bike, | 1 |
| citybi, | city bike, | 1 |
| citybik, | city bike, | 1 |
| citybike, | city bike, | 1 |

The above candidates in Table 2 may handle user searches where users do not type in any space as word delimiters between tokens.

After all user searches and their corresponding tuples are generated, the frequency may be aggregated for each (prefix, complete query) pair and summed up so that the frequency for each pair may be compared against other pairs that have the same prefix, but a different complete query. This data will allow a complete query to be predicted based on a future user search that starts with a given prefix. The complete queries that occur more often given a prefix are preferred over complete queries that do not occur as often given the same prefix. Each (prefix, complete query) pair, may be sorted by the pair's aggregated frequency and the most frequent candidates may be kept and/or stored in distributed cache with the prefix as the lookup key. When a prefix lookup comes in, the distributed caches may pull up the complete query associated with the prefix and communicate them to the backend of the webpage 2200.

It should be appreciated that the specific examples in FIGS. 22-25 are non-limiting and for illustration purposes only. Any desired user search 2280 may be entered in the search field 2210 by the user which will produce different suggested searches 2250, extensions 2240 and related domain names 2260 for the user to select. Also, while the user search 2280 of “bikechain” produced only two tokens, other user searches may produce additional tokens and the invention is not limited to any specific number of tokens.

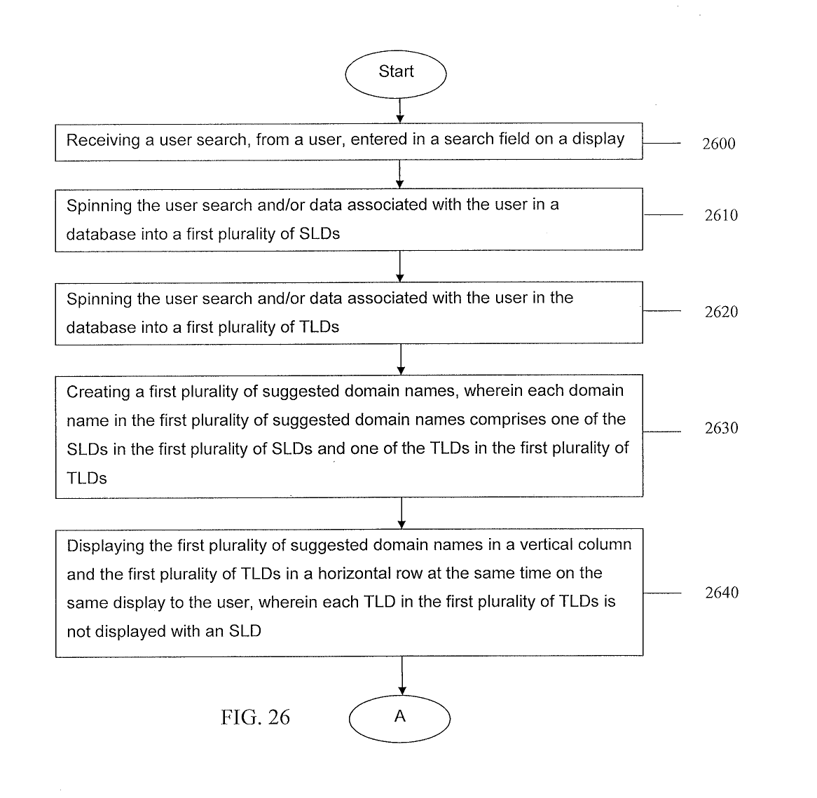

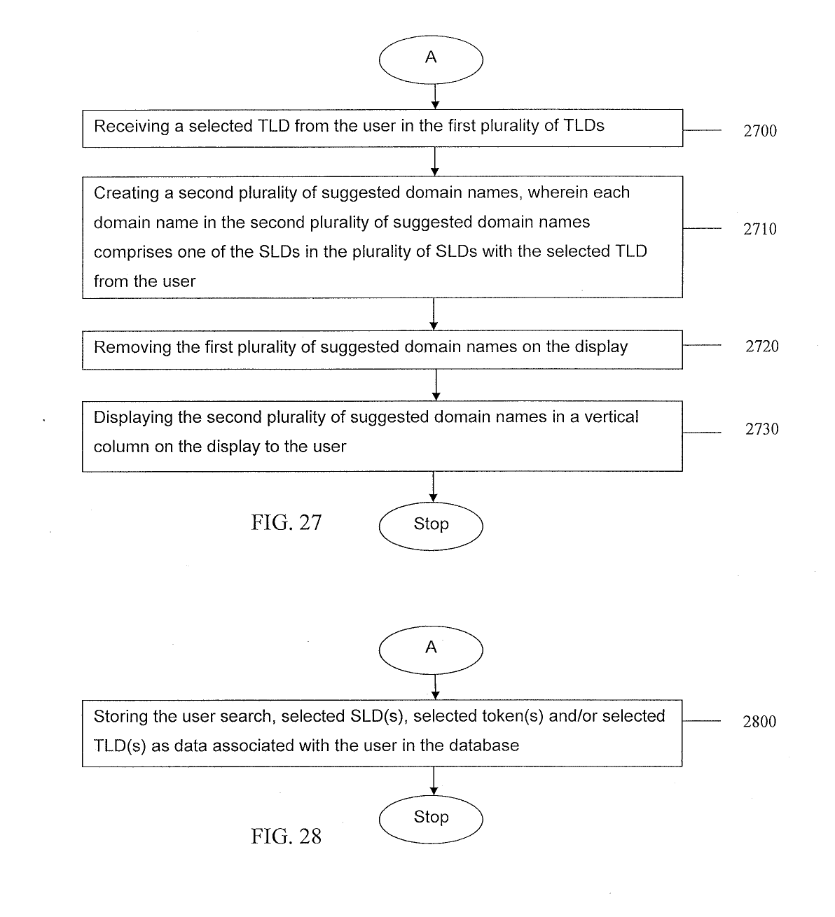

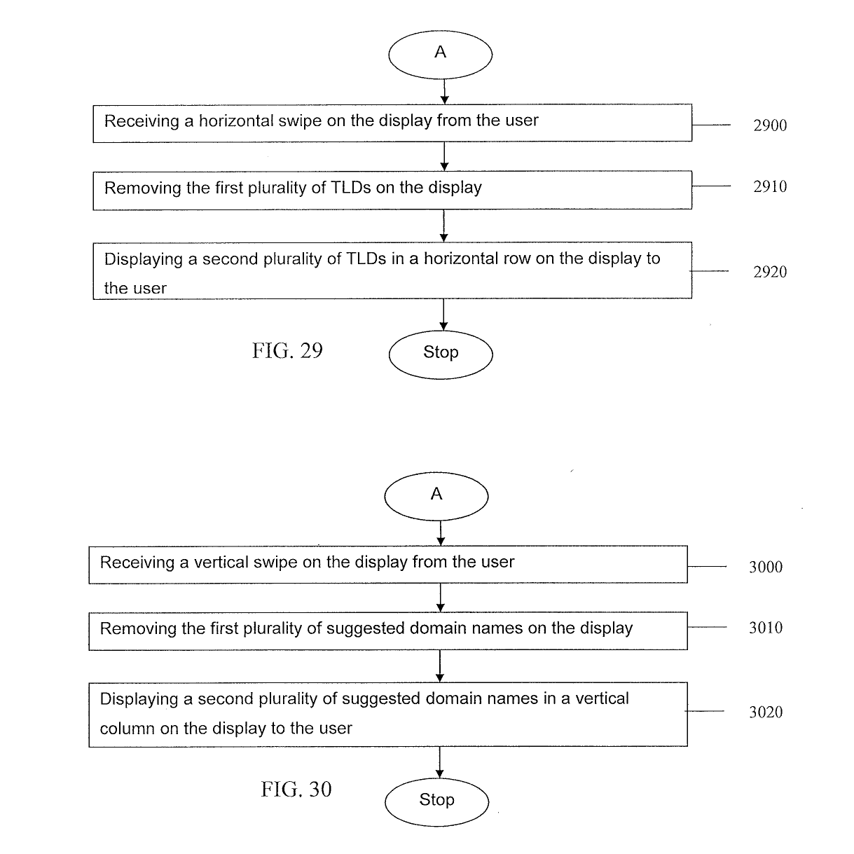

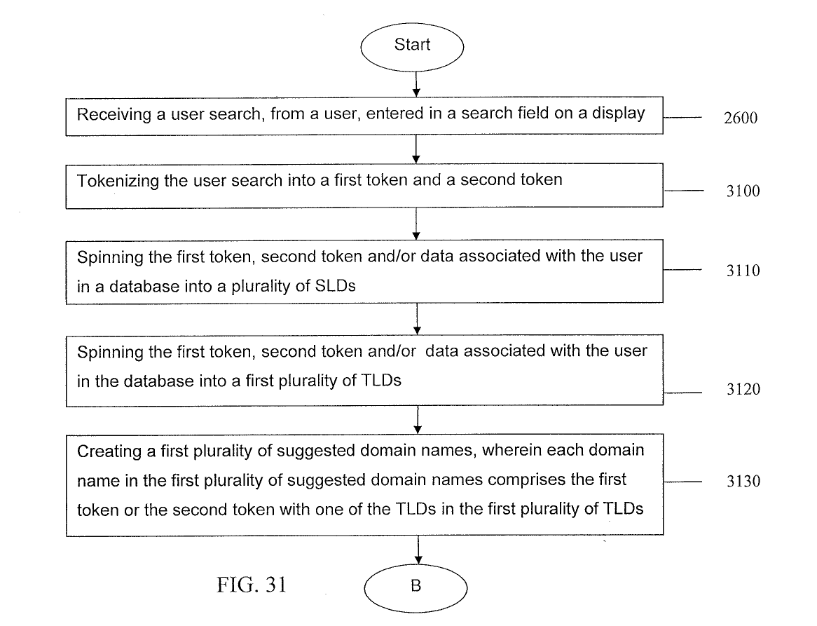

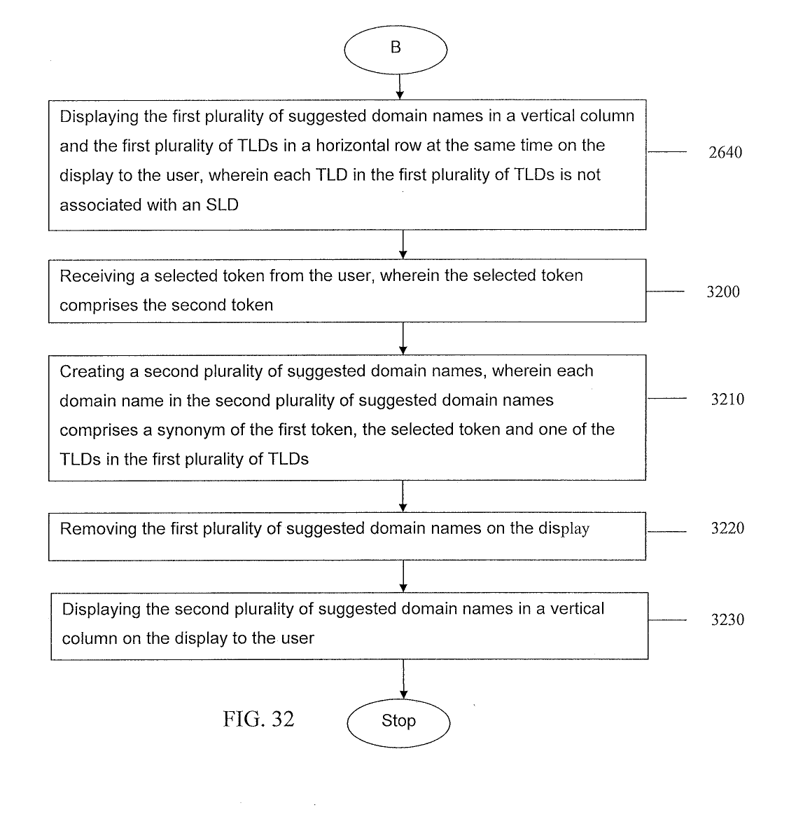

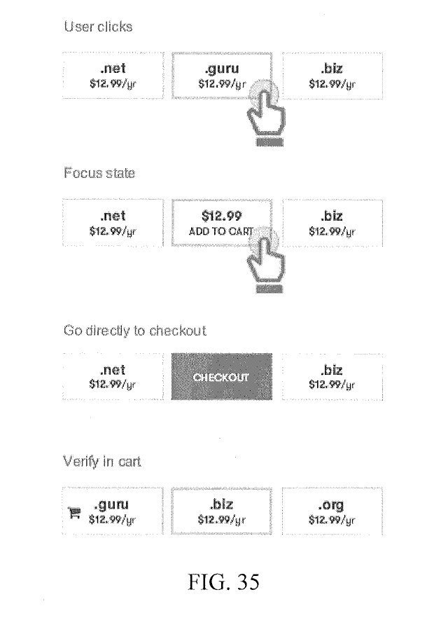

FIGS. 26-35 illustrate additional embodiments for creating one or more pluralities of suggested domain names 3300. In the embodiments illustrated in FIGS. 26-35, when a TLD 3400 is stated to be displayed, the TLD 3400 is displayed without an SLD. These embodiments are particularly efficient for a user to use on a cell phone or other mobile device with a small display. The mobile device may be, as non-limiting examples, wearable electronics or watches. These embodiments allow the user to lock one or more SLDs, one or more tokens within an SLD and/or one or more TLDs 3400 and then spin the remaining SLDs, tokens and/or TLDs 3400 to produce a plurality of suggested domain names 3300 and suggested TLDs 3400 to display to the user. Alternatively, the user may select one or more SLDs, one or more tokens within an SLD and/or one or more TLDs 3400 and then spin the selected SLDs, tokens and/or TLDs 3400 to produce a plurality of suggested domain names 3300 and tokens to display to the user.

These embodiments may start by receiving a user search 3310, from a user, in a search field 3320 on a display. (Step 2600) The search field 3320 may be on a webpage or on an application/widget running on a computer or mobile device. The user may type (or say the user search for audio input enable devices) the user search 3310 into the search field 3320. The user search 3310 may comprise one or more characters, but preferably comprises one or more words and/or tokens (each token is preferably a word).

The backend of the webpage or application may receive the user search 3310 and/or data associated with the user (past user search history, past selected tokens, past selected and/or registered TLDs, current location, registered domain names, first and last names of the user, category of any known websites and/or businesses, etc.). Data associated with the user may be read from a database. The user search 3310 and other data regarding the user (perhaps the user's current location) may be stored in the database for future use. (Step 2800)

The backend may spin the user search 3310 (which may be tokenized into one or more tokens) and/or the data associated with the user to produce a plurality of Second-Level Domains (SLDs) (Steps 2610 and 3110) and a plurality of Top-Level Domains (TLDs 3400) (Steps 2620 and 3120). The spinning of the user search 3310 and/or data associated with the user may use any desired method, including any previously described method for spinning domain names. Non-limiting examples of spinning include reordering the tokens, adding tokens, removing tokens and/or replacing the SLD or tokens within the SLD and/or the TLD with synonyms, folksonomy related tokens, SLDs previously entered by the user and/or tokens and/or other words determined to be associated with the user.

The backend may create a plurality of suggested domain names 3300 by combining one of the plurality of SLDs and/or tokens within the user search 3310 with one of the plurality of TLDs. (Steps 2630 and 3130) The plurality of suggested domain names 3300 are preferably displayed in one, and only one, vertical column at the same time as the plurality of TLDs 3400 are displayed in one, and only one, horizontal row. (Step 2640)

In another embodiment, the plurality of suggested domain names 3300 may be displayed in a single horizontal row at the same time as the plurality of TLDs 3400 are displayed in a single vertical column. An option may exist on the display for the user to switch between displaying suggested domain names 3300 or suggested TLDs 3400 in a vertical column to a horizontal row or vise versa. As these embodiments are particularly effective on mobile devices with small displays, the terms vertical column and horizontal row may be considered interchangeable (as long as there remains one and only one vertical column and one and only one horizontal row on the display) as mobile devices may be easily rotated in the user's hands.

In either case, no other TLDs or Domain Names are displayed on the device at the same time the user search 3310, the plurality of suggested domain names 3300 in a single column or row and the plurality of TLDs 3400 in a single column or row are displayed. Having only the user search 3310, the plurality of suggested domain names 3300 and the plurality of TLDs 3400 on the display removes clutter and makes it easier for the user to find a desired domain name and/or a desired TLD. Both embodiments are particularly advantages for mobile devices (such as cell phones) that have a limited display area.

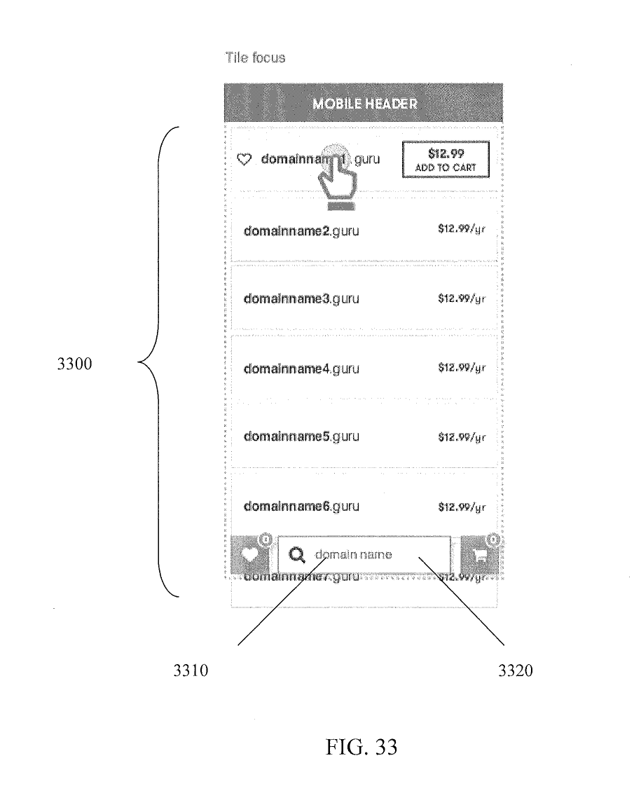

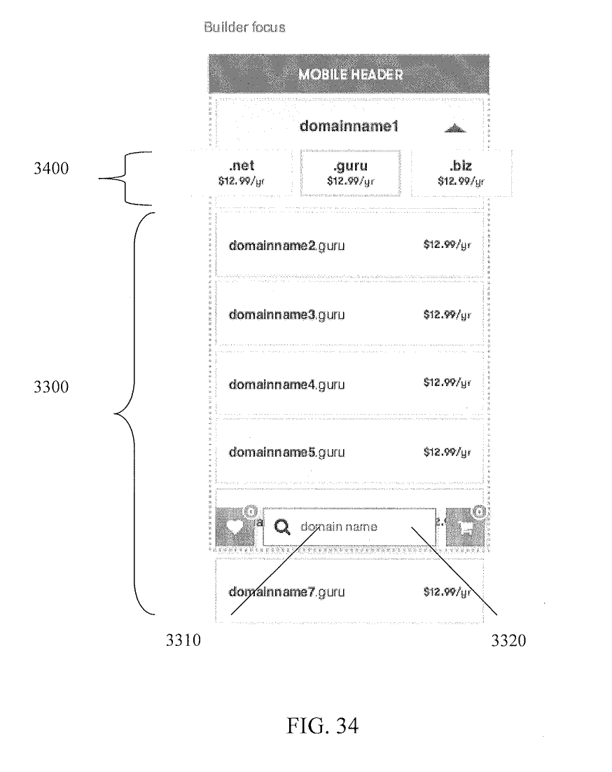

FIGS. 33-34 illustrate possible embodiment with a single (one and only one) column of suggested domain names 3300 and a single (one and only one) row of TLDs 3400 and a user search 3310 with no other domain names or TLDs displayed.

In some embodiments, the user search 3310 may be tokenized into one or more tokens that are displayed to the user. (Step 3100) The user may select one or more of the tokens (Step 3200) and/or one or more of the plurality of TLDs 3400 (Step 2700) displayed to the user by, as a non-limiting example, touching the token(s) and/or TLD(s) 3400 on the display of the mobile device. The selected token(s) and/or TLD(s), depending on the desired user experience, may either be locked in place (all suggested domain names 3300 will include the locked token(s) or TLD(s)) or be spun (all non-selected token(s) and/or TLD(s) are locked in place and only the selected token(s) and/or TLD(s) are spun). A second plurality of suggested domain names 3300 and/or TLDs 3400 (Step 3120) may be created based on which token(s) and/or TLD(s) the user desires to lock or spin. (Steps 2710, 3110 and 3210) The second plurality of suggested domain names 3300 may be displayed while the first plurality of suggested domain names 3300 on the display may be removed (possibly by merely writing the second plurality of suggested domain names 3300 over the top of the first plurality of suggested domain names 3300 would remove the first plurality of suggested domain names 3300). (Steps 2720 and 3220) This may result in the second plurality of suggested domain names 3300 appearing in a vertical column and the same or a second plurality of TLDs 3400 appearing in a horizontal row on the display to the user. (Steps 2730 and 3230) In preferred embodiments, no other domain names (other than the suggested domain names 3300 in the vertical column and/or in the user search 3310) and no other TLDs (other than the TLDs 3400 in the horizontal row or in the user search 3310) are displayed on the device to the user.

In another embodiment, the user may perform a vertical swipe on the display to display additional suggested domain names 3300 (if the suggested domain names 3300 are being displayed in a vertical column) (Step 3000) or additional TLDs 3400 (if the suggested TLDs 3400 are being displayed in a vertical column). In a similar manner, the user may perform a horizontal swipe on the display to display additional TLDs 3400 (if the suggested TLDs 3400 are being displayed in a horizontal row) or additional suggested domain names 3300 (if the suggested domain names 3300 are being displayed in a horizontal row). (Step 2900) The additional suggested domain names 3300 and/or the additional suggested TLDs 3400 may be created at the time of the vertical or horizontal swipe by the user, but are preferably created (but not displayed) when the other displayed pluralities of suggested domain names 3300 and displayed TLDs 3400 were created. Pre-swipe (either horizontal or vertical) suggested domain names 3300 and/or TLDs 3400 may be removed (Steps 2910 and 3010) merely by displaying the additional suggested domain names 3300 or the additional TLDs 3400 in the same column or row as the pre-swipe suggested domain names 3300 and/or TLDs 3400. (Steps 2920 and 3020)

Swiping (whether vertical or horizontal) includes moving a hand (or fingers) across a touch screen display while touching the display and also includes moving a hand (or fingers) in front of a display that senses motion without touching the display. In other embodiments, voice commands may be used to select SLDs, tokens and/or TLDs, create and display new suggested domain names 3300 and/or select a domain name to be registered to the user. A single swipe may step through additional suggested TLDs or additional suggested domain names one at a time. In another embodiment, the velocity, push force on the display, length of time between swipes and/or length of the swipe may be measured to let the user control an automated carousal of TLDs and/or suggested domain names 3300. The TLDs and/or suggested domain names 3300 may sequentially appear to the user at a speed controlled by the user. The user may also stop the automated carousal of TLDs and/or suggested domain names 3300 when desired by touching a single spot on a display for a period of time or holding a hand or finger motionless for a period of time. In some embodiments, the user may be able to generate and display new suggested TLDs at the same time new suggested domain names 3300 are also generated and displayed to the user. In this embodiment, the user may swipe in the vertical direction and then the horizontal directions (or the other way around) within a short time span (less than a few seconds). This would allow the user to see (and thus select) new TLDs and new suggested domain names 3300 at the same time.

In another embodiment, the user may select a search request to initiate the process of: 1) receiving the user search 3310, 2) spinning the user search 3310 and data associated with the user into a plurality of SLDs and TLDs, 3) creating a plurality of suggested domain names 3300 and suggested TLDs based on the plurality of SLDs and TLDs and 4) displaying the suggested domain names 3300 in one and only one vertical column and displaying the suggested TLDs 3400 in one and only one horizontal row on a display to the user.

It should be noted that the displayed SLDs, tokens and/or TLDs 3400 may be locked and/or unlocked any number of times, in any order and in any combination and additional search requests may be requested at any time during the process. Further, new user searches may be entered by the user at any time during the process. In preferred embodiments, no other domain names or other TLDs are displayed to the user when the one and only one vertical column of suggested domain names 3300 (possibly with pricing information), the one and only one horizontal row of suggested TLDs 3400 (possibly with pricing information) and the user search 3310 are displayed to the user. This scheme of displaying information greatly simplifies the process for the user in locking and unlocking SLDs, tokens and TLDs. In addition, the user may select and register any of the suggested domain names 3300 at any time in the process.

As an example of the above described processes, a user may enter the user search of “happy_mouth” and taps search (or search request). A plurality of suggested domain names 3300 may be displayed, with one of the displayed suggested domain names 3300 being “happy_mouth.dentist.” The user may select “happy_mouth.dentist” and then register the domain name, save it as a favorite or see more like this domain name. In this example, the user may select or lock “.dentist” and/or activate an SLD spinner so that “.dentist” is fixed and the backend spins “happy_mouth.” The backend may create and display, in a single vertical column, a second plurality of suggested domain names 3300 comprising “happyteeth.dentist,” “blissfulteeth.dentist,” “happyteethcleaing.dentist” and “jollymouth.dentist” as examples.

As another example of the above described processes, a user may enter “happy mouth” in a search field 3320 on a webpage or in an application. The user may initiate a search by tapping “search.” The backend may create and display a plurality of suggested domain names 3300 (preferably in a single vertical column) and TLDs 3400 (preferably in a single horizontal row) based on the user search 3310 and/or data associated with the user. The plurality of suggested domain names 3300 may include the domain name “happymouth.dentist” and the user may select this domain name. The user may buy it now, add it to a favorite list or see more like this domain name. In this example the user may lock the token “happy” (by, as a non-limiting example, tapping this token on the display) and the TLD “.dentist” or the user may activate an SLD spinner and then select an option to show more like this domain name. If the token “happy” and the TLD “.dentist” are locked, then the backend may focus on spinning the token “mouth” to produce a new batch of suggested domain names 3300 which could comprise, as examples, “happyteeth.dentist,” “happygums.dentist” and “happyspeak.dentist.”

As another example, the user may enter happyteeth.dentist into a search field 3320 or the user may select happyteeth.dentist from a list of suggested domain names 3300. The user may lock the SLD “happyteeth” or the user may lock the tokens “happy” and “teeth” by tapping on the tokens on the display. The user may activate the TLD spinner for “happyteeth.dentist.” If “happyteeth” is locked (as described above) then the backend will spin the TLD to produce a plurality of suggested domain names 3300. In this example, the backend may create and display (possibly directly below the starting domain name of “happyteeth.dentist” and as a child group set) the suggested domain names 3300 of “Happyteeth.dds,” “Happyteeth.dental,” “Happyteeth.health,” “Happyteeth.nyc,” “Happyteeth.us.”

The suggested domain names 3300 may be based on past user selections of SLDs, tokens and TLDs as well as other data associated with the user. This data may be stored and read from a database so that current data is stored for later use while past data may be read and used to spin and generate new suggested domain names 3300 comprising SLDs and TLDs. As an example, when a user locks a TLD, that TLD may be saved on a preference list in the database for that user. Future searches would boost that TLD in the suggested domain names 3300 to that user. A similar process may be used for SLDs and tokens that have been locked or selected by the user. User preference for singular or plurals and similar word replacements may also be used to generate future suggested domain names 3300 for the user. Thus if a preference for singular SLDs and/or tokens is detected for a user, future SLD and/or token spins may be biased so that singular SLDs and/or tokens are more likely to be displayed and more likely to be higher on the list of suggested domain names 3300. In this situation, other replacements like word addition would be given less preference in generating new suggested domain names 3400.

The Abstract accompanying this specification is provided to enable the United States Patent and Trademark Office and the public generally to determine quickly from a cursory inspection the nature and gist of the technical disclosure and in no way intended for limiting the present invention or any of its embodiments.

The invention claimed is:

1. A method, comprising the steps of:
a) receiving a user search, from a user, entered in a search field on a display;
b) spinning the user search and/or data associated with the user in a database into a first plurality of SLDs;
c) spinning the user search and/or data associated with the user in the database into a first plurality of TLDs;
d) creating a first plurality of suggested domain names, wherein each domain name in the first plurality of suggested domain names comprises one of the SLDs in the first plurality of SLDs and one of the TLDs in the first plurality of TLDs; and
e) displaying the first plurality of suggested domain names in a vertical column and the first plurality of TLDs in a horizontal row at the same time on the same display to the user, wherein each TLD in the first plurality of TLDs is not displayed with an SLD.

2. The method of claim 1, further comprising the steps of:
f) tokenizing the user search into a first token and a second token;
g) receiving a selected token from the user, wherein the selected token comprises the first token;
h) creating a second plurality of suggested domain names, wherein each domain name in the second plurality of suggested domain names comprises the selected token, a synonym of the second token and one of the TLDs in the first plurality of TLDs;
i) removing the first plurality of suggested domain names on the display; and
j) displaying the second plurality of suggested domain names in a vertical column on the display to the user.

3. The method of claim 1, wherein no other domain names and no other TLDs are displayed on the device to the user at the same time as the user search, the first plurality of suggested domain names in the vertical column and the first plurality of TLDs in the horizontal row are displayed to the user.

4. The method of claim 1, further comprising the steps of:
f) receiving a horizontal swipe on the display from the user;
g) removing the first plurality of TLDs on the display; and
h) displaying a second plurality of TLDs in a horizontal row on the display to the user.

5. The method of claim 1, further comprising the steps of:
f) receiving a vertical swipe on the display from the user;
g) removing the first plurality of suggested domain names on the display; and
h) displaying a second plurality of suggested domain names in a vertical column on the display to the user.

6. The method of claim 1, further comprising the step of:
f) receiving a search request from the user thereby causing steps b) thru e) to be performed.

7. The method of claim 1, further comprising the step of:
f) storing the user search as data associated with the user in the database.

8. A method, comprising the steps of:
a) receiving a user search, from a user, entered in a search field on a display;
b) spinning the user search and/or data associated with the user in a database into a plurality of SLDs;
c) spinning the user search and/or data associated with the user in the database into a first plurality of TLDs;
d) creating a first plurality of suggested domain names, wherein each domain name in the first plurality of suggested domain names comprises one of the SLDs in the plurality of SLDs with one of the TLDs in the first plurality of TLDs;
e) displaying the first plurality of suggested domain names in a horizontal row and the first plurality of TLDs in a vertical column at the same time on the display to the user, wherein each TLD in the first plurality of TLDs is not displayed with an SLD;
f) receiving a selected TLD from the user in the first plurality of TLDs;
g) creating a second plurality of suggested domain names, wherein each domain name in the second plurality of suggested domain names comprises one of the SLDs in the plurality of SLDs with the selected TLD from the user;
h) removing the first plurality of suggested domain names on the display; and
i) displaying the second plurality of suggested domain names in a horizontal row on the display to the user.

9. The method of claim 8, further comprising the steps of:
j) tokenizing the user search into a first token and a second token;
k) receiving a selected token from the user, wherein the selected token comprises the first token;
l) creating a third plurality of suggested domain names, wherein each domain name in the third plurality of suggested domain names comprises the selected token, a synonym of the second token and the selected TLD from the user;
m) removing the second plurality of suggested domain names on the display; and
n) displaying the third plurality of suggested domain names in a horizontal row on the display to the user.

10. The method of claim 8, wherein no other domain names and no other TLDs are displayed on the device to the user at the same time as the user search, the first plurality of suggested domain names in the horizontal row and the first plurality of TLDs in the vertical column are displayed to the user.

11. The method of claim 8, further comprising the steps of:
j) receiving a vertical swipe on the display from the user;
k) removing the first plurality of TLDs on the display; and
l) displaying a second plurality of TLDs in a vertical column on the display to the user.

12. The method of claim 8, further comprising the steps of:
j) receiving a horizontal swipe on the display from the user;
k) removing the second plurality of suggested domain names on the display; and
l) displaying a third plurality of suggested domain names in a horizontal row on the display to the user.

13. The method of claim 8, further comprising the step of:
j) receiving a search request from the user thereby causing steps b) thru e) to be performed.

14. The method of claim 8, further comprising the step of:
j) storing the selected TLD as data associated with the user in the database.

15. A method, comprising the steps of:
a) receiving a user search, from a user, entered in a search field on a display;
b) tokenizing the user search into a first token and a second token;
c) spinning the first token, second token and/or data associated with the user in a database into a plurality of SLDs;
d) spinning the first token, second token and/or data associated with the user in the database into a first plurality of TLDs;
e) creating a first plurality of suggested domain names, wherein each domain name in the first plurality of suggested domain names comprises the first token or the second token with one of the TLDs in the first plurality of TLDs;
f) displaying the first plurality of suggested domain names in a vertical column and the first plurality of TLDs in a horizontal row at the same time on the display to the user, wherein each TLD in the first plurality of TLDs is not associated with an SLD;
g) receiving a selected token from the user, wherein the selected token comprises the second token;
h) creating a second plurality of suggested domain names, wherein each domain name in the second plurality of suggested domain names comprises a synonym of the first token, the selected token and one of the TLDs in the first plurality of TLDs;
i) removing the first plurality of suggested domain names on the display; and
j) displaying the second plurality of suggested domain names in a vertical column on the display to the user.

16. The method of claim 15, wherein no other domain names and no other TLDs are displayed on the device to the user at the same time as the user search, the first plurality of suggested domain names in the vertical column and the first plurality of TLDs in the horizontal row are displayed to the user.

17. The method of claim 15, further comprising the steps of:
k) receiving a horizontal swipe on the display from the user;
l) removing the first plurality of TLDs on the display; and
m) displaying a second plurality of TLDs in a horizontal row on the display to the user.

18. The method of claim 15, further comprising the steps of:
k) receiving a vertical swipe on the display from the user;
l) removing the second plurality of suggested domain names on the display; and
m) displaying a third plurality of suggested domain names in a vertical column on the display to the user.

19. The method of claim 15, further comprising the step of:
k) receiving a search request from the user thereby causing steps b) thru e) to be performed.

20. The method of claim 15, further comprising the step of:
k) storing the selected token as data associated with the user in the database.
